(19) United States
(12) Patent Application Publication
(10) Pub. No.: US 2015/0199770 A1
(43) Pub. Date: Jul. 16, 2015

(54) Social And Commercial Internet Platform for Correlating, Crowdsourcing, and Convening People and Products of Related Characteristics Into A Virtual Social Network

(71) Applicant: Marc Howard Wallenstein, Roswell, GA (US)

(72) Inventor: Marc Howard Wallenstein, Roswell, GA (US)

(21) Appl. No.: 13/937,020

(22) Filed: Jul. 8, 2013

(51) Int. Cl. G06Q 50/00; G06Q 30/06

(52) U.S. Cl. CPC G06Q 50/01; G06Q 30/0605

(57) ABSTRACT

A social network and related database useful for electronic commerce on a computer network, that includes a registry users and related data including profiles, a plurality of websites that publish product reviews, posts, messages, advertisements, providing links from websites based upon shared affinities of users and affinity group websites that allow users to create temporary affinity groups relating to items of commerce and transmitting messages to potential interested users for the purpose of consolidating purchasing power and transmitting information relating to said temporary affinity groups to product vendors.

The applicant claims the benefit of the filing date of U.S. Application No. 61/690,842 filed on Jul. 6, 2012.

This invention is directed to a computer system and distributed network that defines a social community and marketplace and consists of people (or members or subscribers), products, communication posts, and events, that may be manually and/or automatically associated with one another to form communities or sets for the purpose of: socializing product-associated information; contributing and sharing product expertise; rating and reviewing products, brands, and sellers; contributing to a dynamic archive of product and service information, and buying and selling products. The present invention further relates generally to electronic commerce systems, and more particularly, to a system for supporting electronic commerce within social networks.

Social networking websites that allow users to create and post a personal profile and other information online using one or more webpages hosted by the social networking website and then communicate with others are a popular manner to communicate over the internet.

Electronic commerce sites allowing users to post and sell their own products and services (or items on which they receive a commission) have also become popular. However, the integration, including integration of the functionality provided by these two types of sites has been difficult.

The system is preferably provided on the internet wherein a central server or processor which is in communication with a database can be accessed by users over the world wide web. A feature of embodiments of the system are referred to as product and services wiki features which provide information relating to specific consumer products and services; offering products and services for sale to community members, a marketplace that allows for the on-line purchase of products and services. According to embodiments, users or subscribers that form a community or set can band together to create buying clout, and form group buying opportunities and thereby creating economies of scale for product selling to optimizing pricing, and creating a more positive customer experience. In addition members can create and then publicize social events and outings that are not tied to commercial purposes. In further embodiments, a member may create an event and seek sponsors for such events. The website further enable mulit-media collaboration and interaction including videos and photos on the adventures relating to their products. For example, photo of shoes running a road race, or hiking boots climbing a Mountain may be posted. Other users can collaborate in by inquiring and adding to the multi-media conversation

In an exemplary platform, the system enables, manages, and continuously monitors a community and/or marketplace that are defined by shared characteristics of the members. In an embodiment the communities and marketplaces are predetermined or created by the members seeking others with shared interests or requirements. The platform may be enabled on a user interface installations or website created on the site, or as a panel or link on a user's website established on other social networking sites or independent blogs, as well as other third-party websites, blogs, social networks, and other user interfaces so as to create and facilitate the creation of a virtual community.

Users may post a diversity of posts, e.g., including but not limited to, product reviews, product comparisons, product demonstrations, product training, product assembly, product use, product advertisements, and product listing offering a product for sale. Posts by a user can be communicated using a variety of media including, but not limited to, text, graphic, photographs, video, video with audio and combinations thereof. Users may reply to posts using similar media to create interactions among users and products and services.

For example, in an embodiment a product listing appears as a product listing, display or a multi-media post within a particular social network or group. In this example, the listing includes an offer to sell the product in the group buy which includes a fixed price group offer where the price remains fixed during the period of the offer. In an alternative embodiment, the price offered to the group is a declining price offer where the price declines during the offer and where buyers may receive the lowest price at the time the offer expires. In yet a further alternative, the offer may be a rising price group offer where price rises during the offer period until the offer expires. Offers may expire when either a pre-set time or after a maximum allowed total sales threshold is achieved, whichever occurs first. Exemplary users may include buyers, consumers, purchasers, sellers, vendors, retailers, e-tailers, wholesalers, manufacturers, purveyors, product experts, experts, affiliate marketers, a statistical model of a user acting as a user agent.

The system may be structured to enable a user to comment or reply to other user's postings in a social network community. Users may share information relating to products and services or other experience and expertise in a community supported by the system which may include other social media sites, blogs, or other user interfaces. These communities may be accessed by activating a share button or link that facilitates and enables such sharing, and users may email or text message information from the social network community that is supported by the embodiments of the invention.

Aspects of embodiments of the system are structured to allow a user to follow, be associated with, notified about, and join a community with other users and/or products when other users and/or products are engaged, taking actions, and/or convene in a social network community that is accessed through the system.

The system may be configured to enable a user to create his or her biography and, depending on the user's accessibility choices selected during the creation of the biography or later controlled by the user, may enable other users to access such a biography. An exemplary embodiment of the invention can continuously monitor, analyze, and predict, e.g., including but not limited to, a user's actions, beliefs, desires, and/or intentions. The system can therefore use such information to develop, distribute, and or manage content throughout the system. Beliefs, desires, and intentions can be regarded) as a artificial intelligence term. They are definable and predictable and among the elements/attributes can be used to define not only in a database, but also in social graphs.

A further feature of the invention is an auto-association of metadata to a user record generated by a user action process. Conventional and existing software applications often require a user to enter data manually to a database as a condition for providing privileges to the user. For example, before being granted the privileges of using a web based system, a user must subscribe to the particular website and agree to the terms and conditions and join to be members in a group. Membership in the group then allows communication with other group members, participation in group discussions, access to group information, group services (e.g., default group settings), etc. In conventional systems, the subscription step captures data relating to the user and may also act as a screening or matching agent to provision relevant privileges and/or limit access to privileges.

For example, social networks such as LinkedIn, Face Book, and Google+, require a user to enter personal or other information manually, in a form, field, profile, checklist, as a condition for group membership and the privileges associated therein. Essentially, user access to group privileges requires a user to opt-in and provide the requested personal information and to agree to terms and conditions that govern membership of the site.

In an embodiment of the system described herein, manual entry of personal information is available, but is limited and not necessary to perform may of the functions described herein. Instead, the system may allow a user to use the application services without an opt-in condition. In this embodiment, the system monitors and/or logs a user's actions (behavior) with the application and/or other users on the system. The system then uses an algorithm to compute the predetermined data fields that are collected from the interactions with the website and associates the results to create an internal user record, profile, and/or user model. The system then uses this computed result to affect an automated selection of a user privilege and/or use it to automatically grant privileges and/or services to a user. Essentially, a user's use of the application results in the system's automatic assignment to the user of privileges computed from the user's actions.

A limitation of the conventional opt-in method is that it bars and/or limits engagement between opted-in users and external users who may share common or correlated characteristics. This restriction may reduce or chill a larger engagement between all users, e.g., between users who may otherwise share common beliefs, desires, and/or intentions, and between users and the application. An opt-out method, as disclosed in an embodiment of the present invention provides for a larger population of users with similar or correlated characteristics engaged in group actions, that may include forming communities, socializing product information, performing commercial transactions, creating events and more.

For the purposes of this application the term “rally” refers to the creation of a user group that may have a goal or objective. The broader-based opt-out system allows for more current and accurate modeling of users participating in the user group or rally than would be possible in the narrower more static context of an opt-in group. Thus it is an object of the invention to collect capture large groups of users and segregate such users into one or more groups that are defined by shared or correlated characteristics.

The present invention provides a vehicle or platform for the correlation of products and services, the formation of communities of both products and people relating to lifestyles, and convening of products people and information in the form of posts relating to product transaction and other product related interactions. Prior art online commercial product and services listings, referred to as electronic retail or e-tail sites, and associated platforms are generally separate and distinct from platforms that allow users to create social links with respect to such products and services, product listings and related product information. For example, while a website for ecommerce may have or provide access to on-line reviews of products or services offered on the site, and such information may be used in connection with the sale and marketing of the products, prior art ecommerce websites apparently lack a system that allows users to easily establish social contacts or create social networks relating to the products or services with the persons that are submitting such reviews, purchasing such products or services, or accessing information relation to such products and services. In addition, a user could specifically opt out of certain affinities and products relationships by selection criteria provide in the user profile. For example, a vegetarian may not want to see advertisements from restaurants that serve beef.

For example, electronic retailers provide websites and affiliated websites that allow for the purchase of products and services. The retailer will typically display a product or service listing which users engage to activate purchase transactions of the products or services listed. In the current paradigm, users may socialize the product in separate forums and/or on separate platforms, e.g., in an unrelated social network (e.g., Face Book, Twitter, Yahoo Groups, etc.), but there is often not a link or connection between the product or service and a virtual community that may have an interest in the products and services. For example, the social network community may appear to a user using such an instantiation on a third party user interface as if all users were convened together in the same community even though they may be accessing from disparate locations.

The system described herein and its features radically differ from video conferencing, chat rooms, and other widgets designed for communication because it carries the full functionality of the invention as described above. For example, the virtual community includes identifying and correlating characteristics among the users and products and then convening them into a common community, social sharing of information to other social networks, following other members and products. In addition, the system may track third party sites from which product purchases are generated via the rally panel, e.g., for the purpose of making payments to such.

### BRIEF DESCRIPTION OF THE DRAWINGS

FIG. 1 is a flow chart that illustrates the auto association of metadata to a user record generated by user actions process according to an embodiment of the invention.

FIG. 2 is a flow chart that illustrates the step involved when a user joins an interactive multi-media communication or conversation on the website according to an embodiment of the invention.

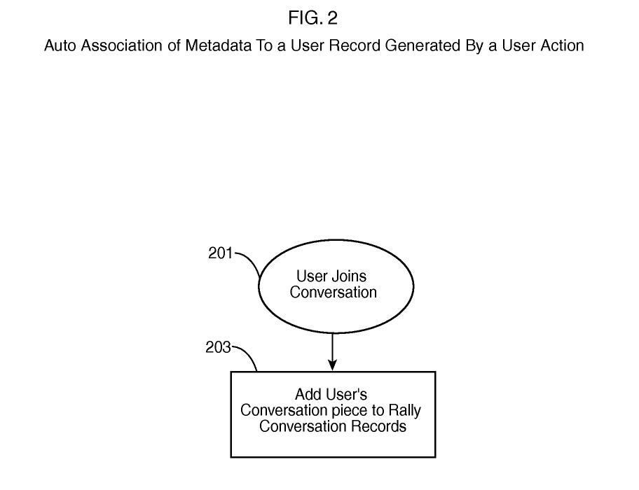

FIG. 3 is a flow chart depicting the initiation of a user's request for a process or service reflected by “in the market” feature of the invention.

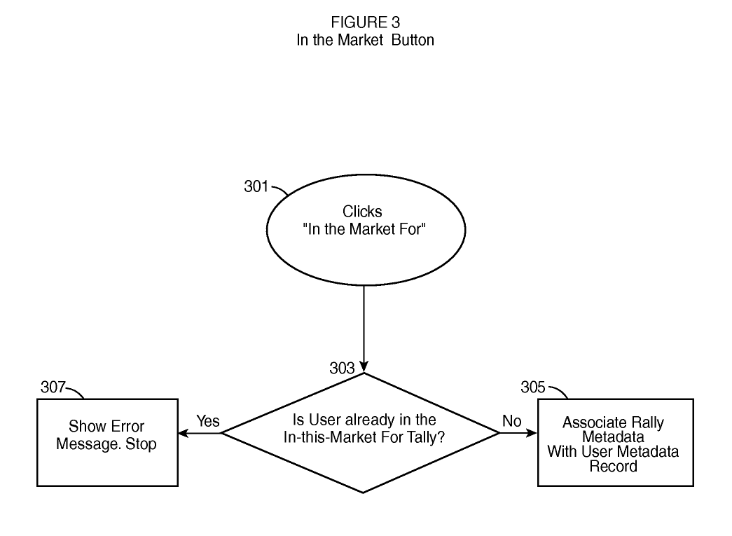

FIG. 4 is a flow chart depicting the registration process for the website according to an embodiment of the invention.

FIG. 5 is a flow chart depicting a portion of the registration process for the website according to an embodiment of the invention.

FIG. 6 is a flow chart depicting the message posting process for the website according to an embodiment of the invention.

FIG. 7 is a flow chart depicting the comment posting process for the website according to an embodiment of the invention.

FIG. 8 is a flow chart depicting a user inquiry posting process for the website according to an embodiment of the invention.

FIG. 9 is a schematic depiction of an exemplary screen display depicting an initial user interface according to an embodiment of the invention.

FIG. 10 is a schematic depiction of an exemplary screen display depicting a registration form data entry fields used in connection of an embodiment of the invention.

FIG. 11 is a schematic depiction of an exemplary screen display depicting additional data entry fields used in connection of an embodiment of the invention.

FIG. 12 is a schematic depiction of an exemplary screen display depicting a personal home page used in connection of an embodiment of the invention.

FIG. 13 is a schematic depiction of an exemplary screen display depicting data entry fields that enable users to post a product review used in connection of an embodiment of the invention.

FIG. 14 is a schematic depiction of an exemplary screen display depicting additional data entry fields used in connection with product review steps according to of an embodiment of the invention.

FIG. 15 is a schematic depiction of an exemplary screen display depicting a user inquiry in connection of an embodiment of the invention.

FIG. 16 is a schematic depiction of an exemplary screen display depicting various active links for product reviews, listings, comparisons and advertisements used in connection with an alternative embodiment of the invention.

FIG. 17 is a screen capture of an exemplary screen display depicting a landing screen used in connection of an alternative embodiment of the invention.

FIG. 18 is a screen capture of an exemplary screen display depicting landing screen for cycling and depicting other selection lifestyle links used in connection of an alternative embodiment of the invention.

FIG. 19 is a screen capture of an exemplary screen display depicting top rally selection links used in connection of an alternative embodiment of the invention.

FIG. 20 is a screen capture of an exemplary screen display depicting product offers relating to a lifestyle selection used in connection of an alternative embodiment of the invention.

FIG. 21 is a screen capture of an exemplary screen display depicting a lifestyle and data fields that may be used to describe and define the lifestyle used in connection of an alternative embodiment of the invention.

FIG. 22 is a screen capture of an exemplary screen display depicting a product relevant to a lifestyle and product reviews and discussion of the product posted by users in connection of an alternative embodiment of the invention.

FIG. 23 is a screen capture of an exemplary screen display depicting information about a group rally feature for a product or service used in connection of an alternative embodiment of the invention.

FIG. 24 is a screen capture of an exemplary screen display depicting information and data entry fields relating to a group rally feature used in connection of an alternative embodiment of the invention.

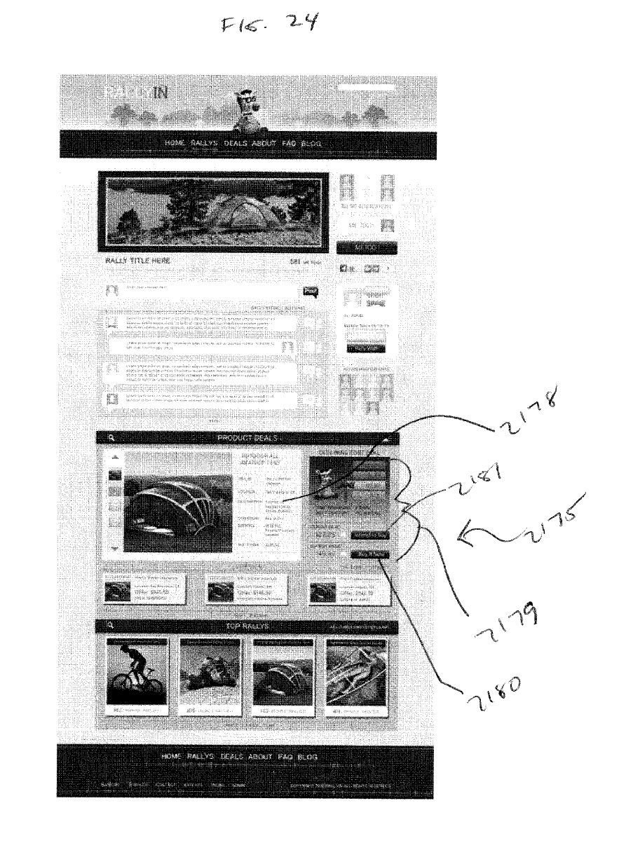

FIG. 25 is a screen capture of an exemplary screen display depicting information and data entry fields relating to a group rally feature used in connection of an alternative embodiment of the invention.

FIG. 26 is a screen capture of an exemplary screen display depicting information and data entry fields relating to a group rally feature used in connection of an alternative embodiment of the invention.

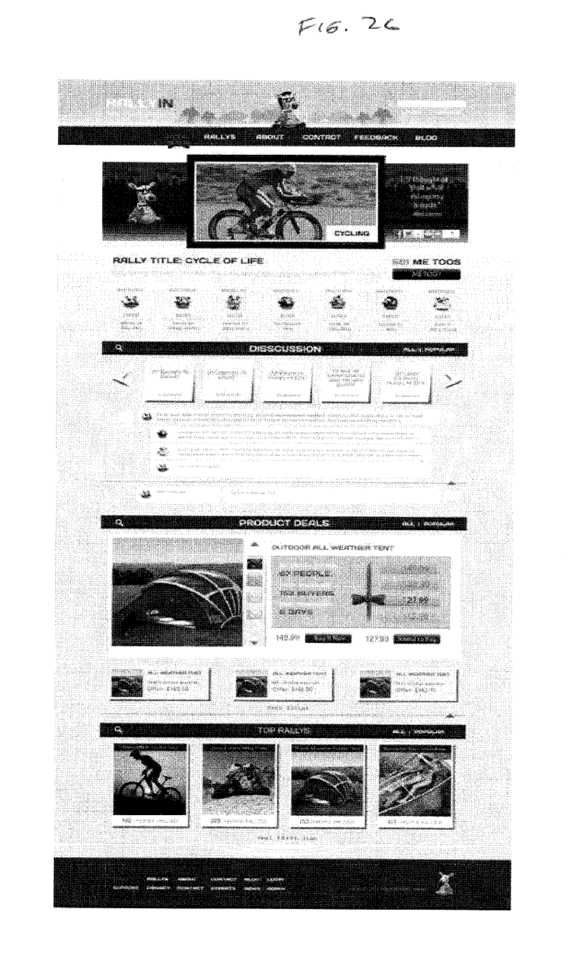

FIG. 27 is a screen capture of an exemplary screen display depicting information and data entry fields relating to a group rally feature used in connection of an alternative embodiment of the invention.

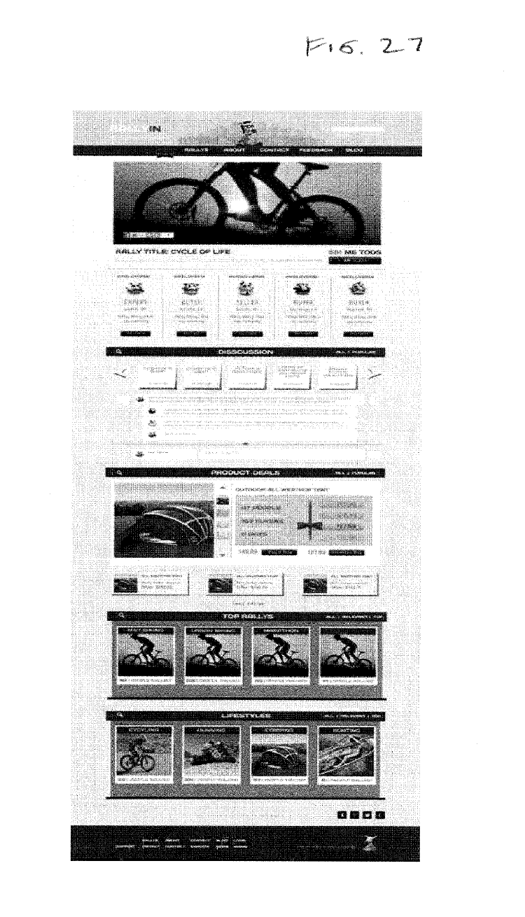

FIG. 28 is a screen capture of an exemplary screen display depicting information and data entry fields relating to a group rally feature used in connection of an alternative embodiment of the invention.

FIG. 29 is a screen capture of an exemplary screen display depicting information and data entry fields relating to a group rally feature used in connection of an alternative embodiment of the invention.

FIG. 30 is a screen capture of an exemplary screen display depicting information and data entry fields relating to a group rally feature used in connection of an alternative embodiment of the invention.

FIG. 31 is a screen capture of an exemplary screen display depicting information relating to the website and invention.

FIG. 32 is a screen capture of an exemplary screen display depicting a feedback feature according to alternative embodiment of the invention.

FIG. 33 is a screen capture of an exemplary screen display depicting data fields available to users to provide feedback to website administrators.

FIG. 34 is a block diagram illustrating a system for implementing the invention in accordance with an embodiment of the invention.

FIG. 35 is a block diagram of a computer system that may be used and that has been configured with an embodiment of the invention.

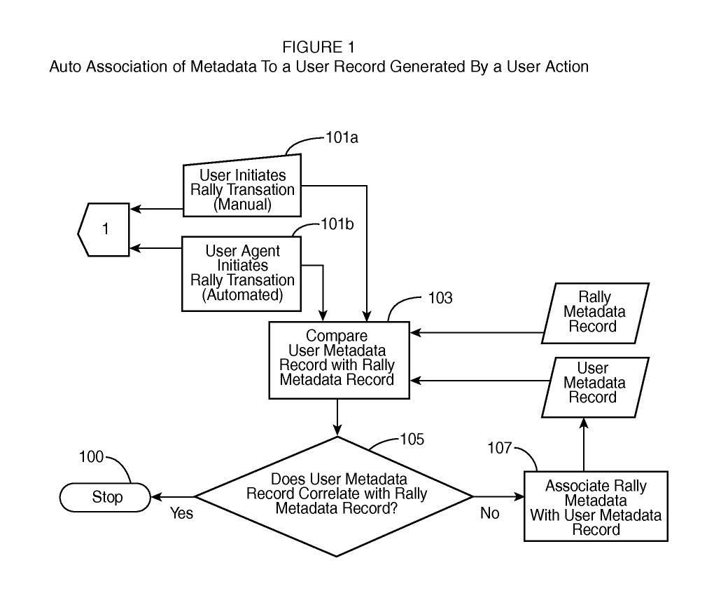

Now referring to FIG. 1, the auto-association of metadata to a user record generated by a user action process is schematically depicted. In an embodiment of the invention as shown in FIG. 1, the processor of the system will poll or continuously monitor and log a user's actions and stores the information relating to the user in a database. The data relating to the user is referred to as user metadata. At step 101a, a user, (which may be a buyer, consumer, seller, vendor, customer, expert, product expert, affiliate marketer, product reviewer, commenter, and/or an automated statistical model acting as an agent of an exemplary user thereto as shown in step 101) can access the site or platform and initiate an action.

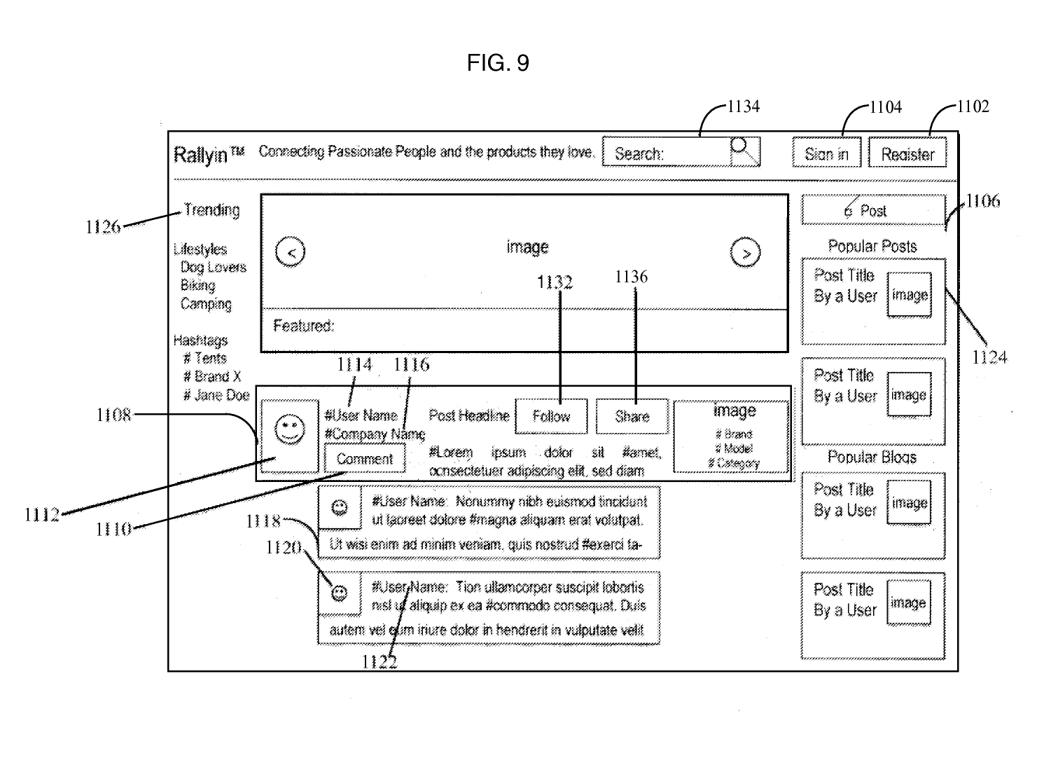

After a user is granted access to the site, an action may be initiated by, e.g., including but not limited to, an exemplary automated statistical model acting as a user agent as represented in step 101b, and/or manually as represented in step 101a via an exemplary user interface, e.g., as shown in all of the exemplary User Interfaces included herein. As shown in the exemplary user interfaces at FIGS. 9-16, an exemplary user action may include, e.g., but is not limited to:
(1) Creating and/or starting a user interface “Rally (Lifestyle Center)—A”; “Rally (Lifestyle Center)—B”; “Rally (Lifestyle Center)—C”; “Rally (Lifestyle Center)—D”;
(2) Posting a belief, desire, and/or intention in a user interface, e.g., including but not limited to the following interfaces: “Home Page—A”, “Home Page—E”, “Home Page F”, “Product Listing (Deal)—A”, “Product Listing (Deal)—B, “Rally (Lifestyle Center)—A”, “Rally (Lifestyle Center)—B”, “Rally (Lifestyle Center)—C”, “Rally (Lifestyle Center)—D”, etc. An exemplary belief, desire, and/or intention may include, but is not limited to, product opinion, product expertise, product reputation, brand reputation, seller reputation, user product experience, user product review, product recommendation, how to use a product, a product wiki, etc. An exemplary belief, desire, and/or intention may be posted as a text comment, graphic, photo, video, video with audio;
(3) Indicating an exemplary desire, which may include but is not limited to, activating (i.e., clicking on) an object, a button, checkbox, a tally, making an entry into a field, etc. to indicate e.g., including but not limited to, “I'm in the Market For”, “Me Too”, etc. as shown in some of the exemplary User Interfaces set forth in FIGS. 9-16
(4) Indicating an exemplary intention, as shown in some of the exemplary User Interfaces included herein, including, e.g., but not limited to, a “I intend to Buy” button, “Buy Now” button, “Go Live with My Deal”, etc. An exemplary intention may be indicated by, e.g., including but not limited to, activating (i.e., clicking on) an object, a button, checkbox, a tally, making an entry into a data entry field;
(5) Following a user initiated action as depicted in FIG. 1, 101a and/or 101b,—the system first compares metadata associated with the user that initiated an action with metadata associated within a rally (Lifestyle Center) in which the action is initiated. The comparison may be performed using a processor running an algorithm, a look-up table or by other comparisons of statistical data that is acquired from the action.
As shown in step 105, the processor for the system executes an algorithm to determine whether metadata associated with a rally (Lifestyle Center) and/or its elements matches and/or is correlated with metadata associated with a user that initiated an action in the same rally.

If the comparison results from step 105 indicate no match and/or no correlation, then, as represented in step 107, the system proceeds to take metadata associated with the rally and/or its elements and associate it with the user that initiated the action in the same rally and/or its elements.

If the comparison results in step 105 indicate a match and/or correlation, than the system proceeds to the step 109, and terminates the process as depicted in FIG. 1.

Exemplary metadata in a particular rally or element of a rally may include, e.g., but is not limited to, a tag, a hash tag, an attribute, a characteristic, a passion, an interest, an activity, an expertise, a user belief, a user desire, a user intention, a user type, a targeted user, a targeted user type, a user profile, a username, a user action, a user purchase, a user sales offer, a seller's deal terms, a sales offer condition, a price, a pricing structure, a price elasticity, a product, a product type, a brand, a product term, a quantity, a product quantity available, a product quantity remaining, a tally, a time elapsed, a time remaining, a time, a date, a day, a season, a population, a population of users, a rating, a ranking, a comment, words in a comment, an analysis of a comment, an association between a user and a user, an association between a user and a product, an association between a product and another product, an object, a class, and a search term used in a search engine. Other metadata may be collected from a user biography.

A schematic illustration of user interface for the system is depicted in FIG. 9. The system may output data stored in or available to the system via a browser, mobile browser, software application, etc. and present it as a user interface, e.g., including but not limited to as a web page, home page, index page, popup window, modal window and software application display.

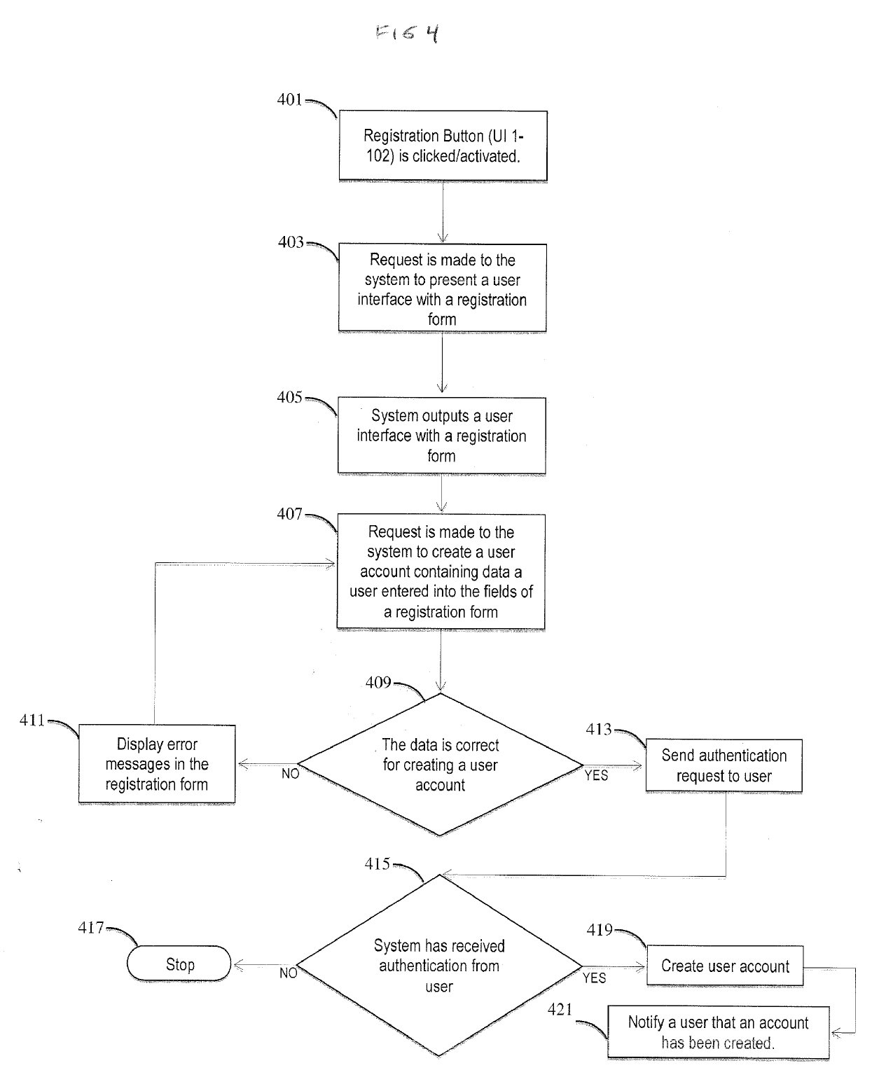

A user may create an account in the system according to the process depicted in FIG. 4. In an exemplary depiction of a user registration shown in FIG. 4, a user may begin by submitting a request to the system 401 to present a user a registration form, which may also be called, e.g., including but not limited to a sign-up form, new user form, etc. To make such a request, a user may click on a Registration button exemplified in the user interface depicted in FIG. 9 at link 1102. The button may also appear as an icon, link, object, etc. and may be located on a home page or in any user interface in the system.

As shown in FIG. 4, when an exemplary registration button is clicked, a request may be made to the system to display or present to a user—with a user interface containing a user registration form 403. When the system receives a request for a registration form, the system may output a user interface containing a registration form 405.

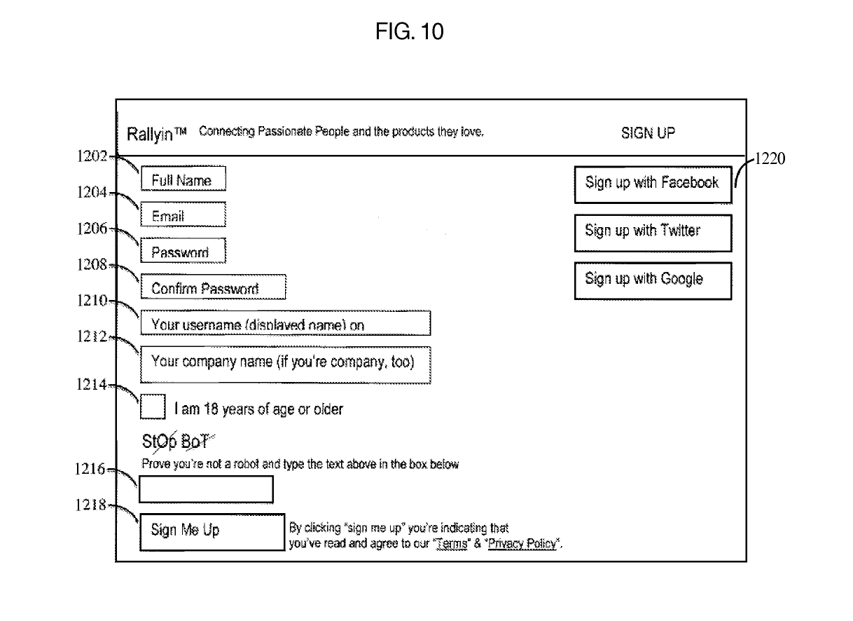

As depicted in FIG. 10 a registration form, may require, or optionally require, a user to input information, e.g., including but not limited to a user's full name 1202, a user's email address 1204, a user's password 1206, a user's confirmation of a password 1208, the user name a user wants to use and display when posting or mentioned in the system and/or system's user interface 1210, a user's company name if the user is also representing a company, including but not limited a for profit entity, non-profit entity, government organization 1212, a declaration by a user that the user is of a required minimum age 1214, a Captcha 1216 (a required data entry to demonstrate that the user is not an automated or machined operated processor or robot), an object such as a button, link, that when accessed and selected initiates the inputs of data from the fields into the system 1218.

In alternative embodiments, a user can be provide points or credits when certain products are posted and each time they are tagged. Such may be sponsored by a brand owner. For example, a brand owner may initiate a rally or temporary affinity group website to see how many photos of its brand of shoe is worn at a particular road race and give users incentives to post their brand of shoes. Points or credits can be traded for cash or prizes.

Alternatively, in lieu of entering data in fields like those depicted in User Interface depicted in FIG. 10, fields 1202 through 1218, a user may opt to use “social sign-in” to register, e.g., by clicking a social network button 1220 depicted in a registration form. Social sign-in enables a user to create an account by entering sign-in credentials, e.g., a username, password, etc., that a user may already have in a social network, e.g., including but not limited to Facebook, Twitter and Google.

Now referring to FIG. 4, the process wherein a user may submit a request containing registration data to the system and to create an account that contains the submitted registration data 407 is depicted. Alternatively, a user may make such a submission, for example, by clicking a button (“Sign Me Up” button) as depicted in the user interface depicted in FIG. 10 at reference no. 1218. As shown in step 409 of FIG. 4, if registration form data submitted via a registration form is not correct—i.e., the data does not meet (is not equal to) required business rules in the system—then the system may output and display an error message 411 in the registration form. A user may then correct errors (by entering different data in a registration form) and resubmit at step 407. If the registration form data submitted via a registration form is correct—i.e., meets (is equal to) required business rules in the system—then the system sends an authentication request at step 413 to a user who submitted a registration form. An authentication is a request sent to a user asking a user to authenticate that the user is in fact the individual who has requested creation of an account. An authentication may be sent e.g., including but not limited to, via email, text, phone call, etc. An authentication may require a user e.g., including but not limited to, to click a link in an email, enter a code in a text message and send it, etc. An authentication request sent to a user may expire after any specified time period if a user does not respond to the authentication request within a specified time period. If the system does not receive an authentication, e.g., within a specified time period, from a user who has been sent an authentication, at step 417 then the system does not create a user account. The system may also expunge data a user registered to create an account where the system has not received an authentication from a user.

If the system receives an authentication, e.g., within a specified time period, from a user who has been sent an authentication, at step 419 the system create a user account containing the data the user submitted in the registration form. Next the system notifies a user that an account has been created at step 421 including displaying a message in the user's interface and sending an email to a user who created an account.

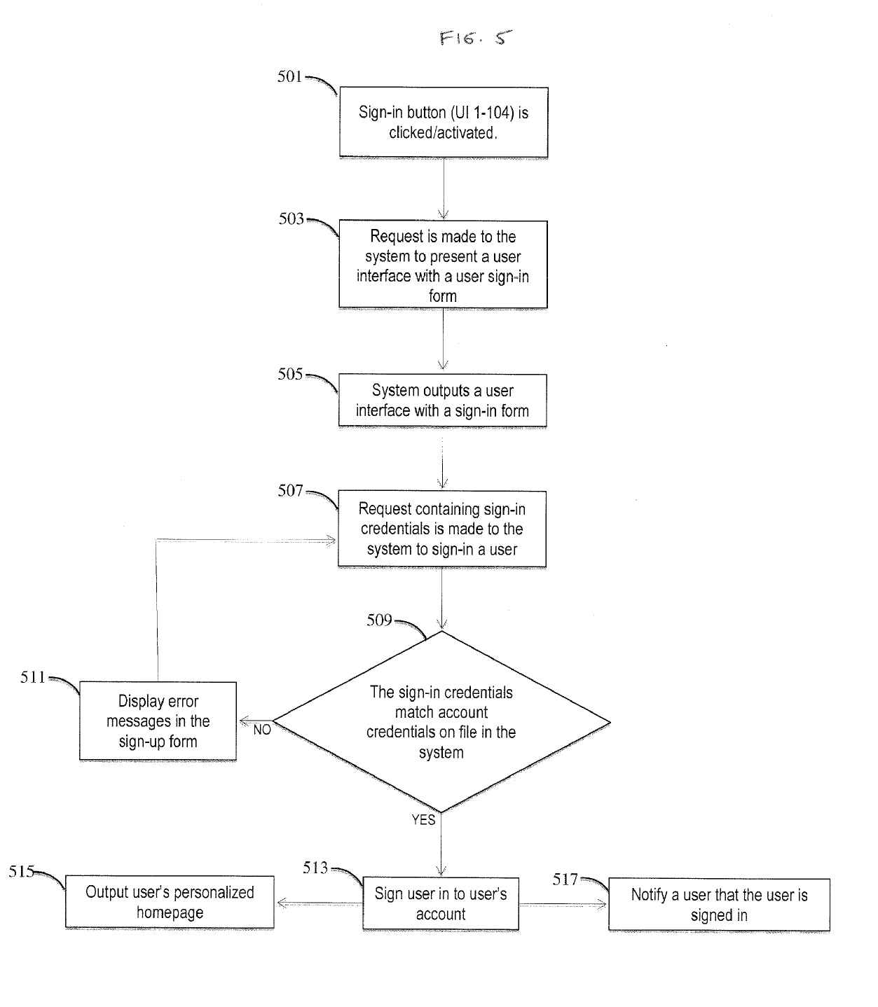

After successfully establishing an account, a user may access the website and sign-in to the account. Sign-in may alternatively be called login. Signing in to an account may afford a user privileges not available to a user who is not signed into an account. An exemplary depiction of a user sign-in process is depicted in FIG. 5. A user begins by submitting a request 501 to the system to sign in. To make the sign-in request a user activates a Sign-in button or link 1104 depicted in the user interface at FIG. 9. The button 1104 may also appear as an icon, link, or object and may be located on a home page or in any user interface in the system.

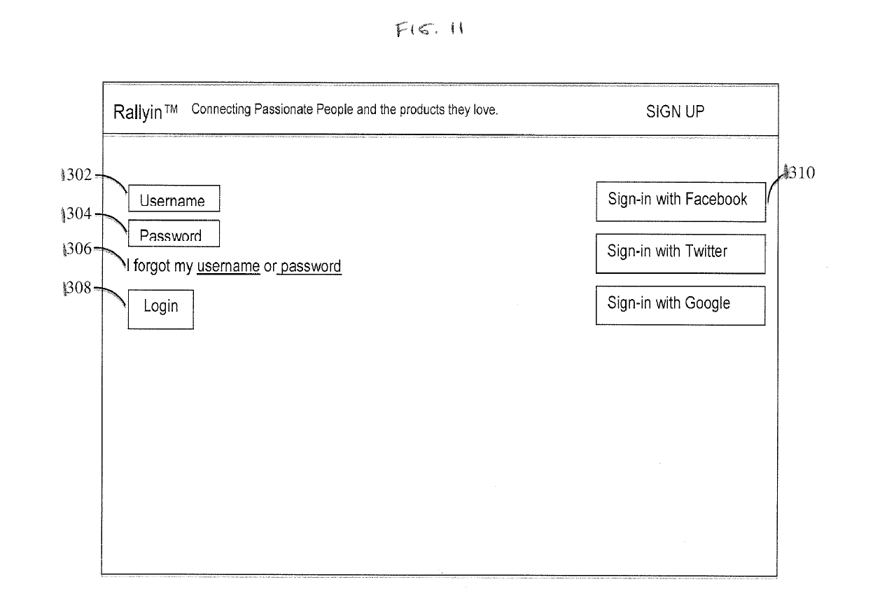

Referring back to FIG. 5, when the sign-in process is activated a request is made to the system to display a user interface containing a sign-in form 503. Next, the system may output a user interface containing a sign-in form 505. As shown in the user interface depicted in FIG. 11, a sign-in form may require a user to input sign-in credential information, e.g., including but not limited to a user's username 1302), password 1304, and email address. Alternatively, in lieu of entering data in fields like those depicted in User Interface 3, fields 1302 through 1304, a user may opt to use “social sign-in, e.g., by clicking a social network sign-in button 1310 depicted in a sign-in form. Social sign-in enables a user to sign in to an account by entering sign-in credentials, e.g., a username, password, etc., that a user may already have in a social network, e.g., including but not limited to Facebook, Twitter, and Google.

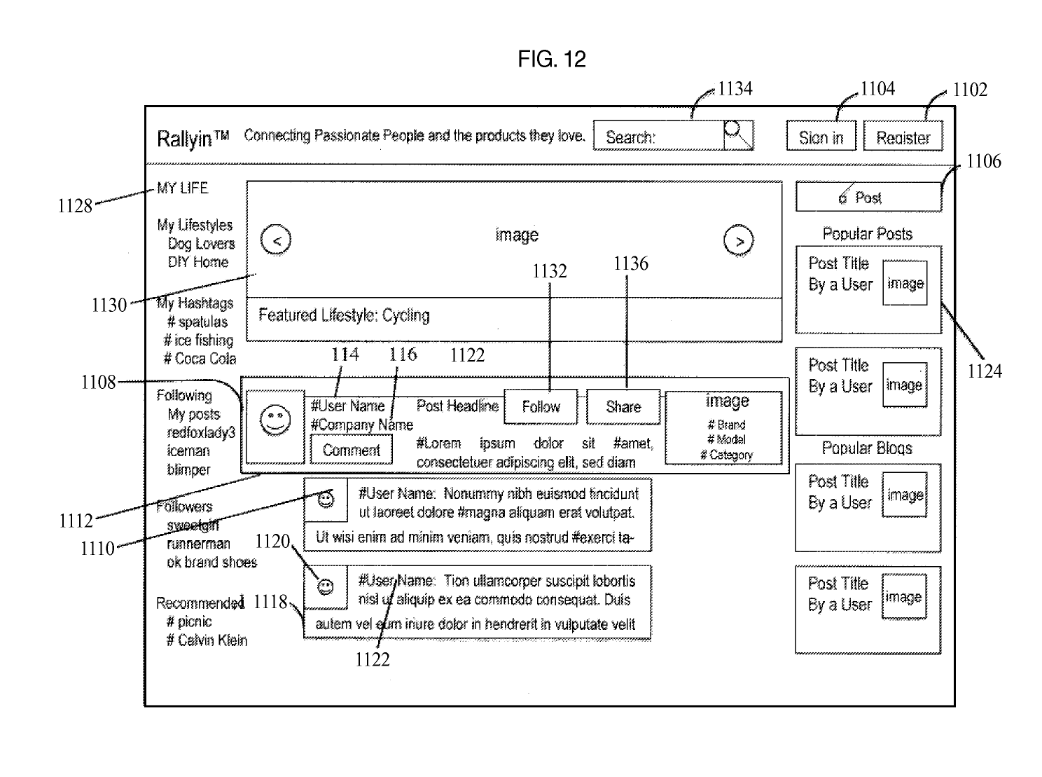

Now referring to FIG. 5, a user may submit a request containing sign-in credential data to the system to sign a user into his/her account 507. A user may make such a submission, for example, by clicking a button—a “Login” link—as depicted in the User Interface if FIG. 11 at link 1308. At step 509, if sign-in form data submitted via a sign-in form is not correct—i.e., the data does not meet (is not equal to) sign-in credentials stored in the system—then the system may output and display an error message 511 in the sign-in form. A user may then correct errors by entering different data in a registration form and resubmit a form at step 507. At step 509 if the data submitted via a sign-in form is correct—i.e., meets (is equal to) sign-in credentials stored in the system—then the system may sign a user into his/her account. Next, the system outputs a user's stored personalized home page 515 and simultaneously may notify a user that he/she is signed in to the user account at step 517. For example, the system may display a message in a user interface, e.g., “Hello Username.” An exemplary personalized home page is depicted in the user interface depicted in FIG. 12.

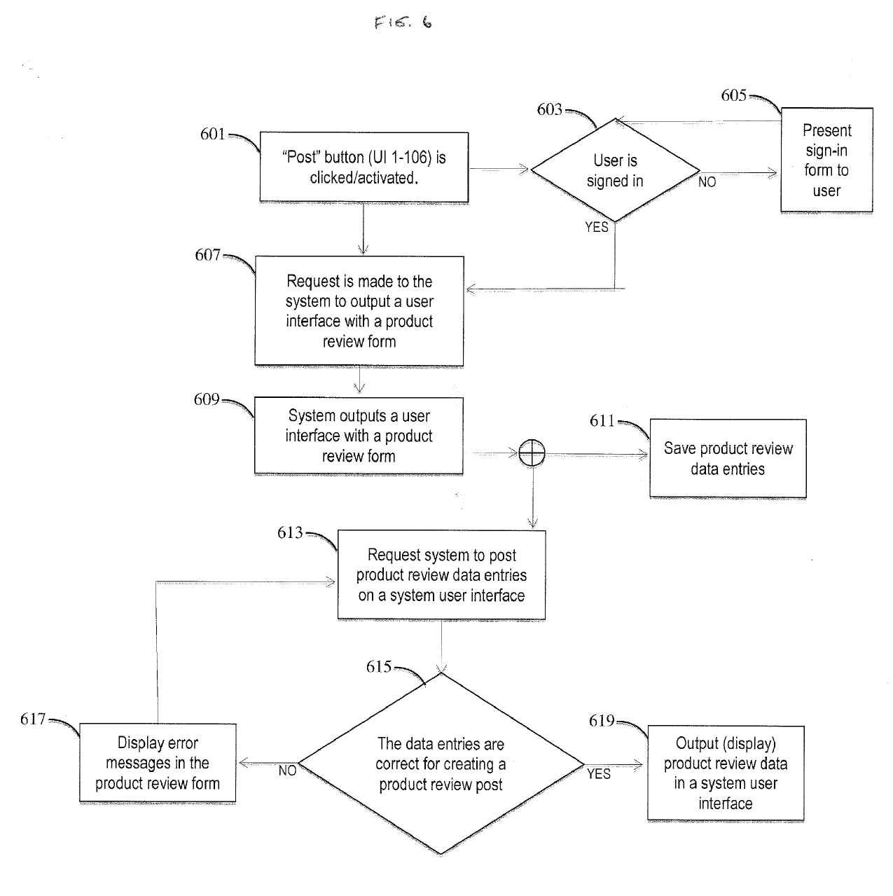

A further feature of the system allows users to post a product review. A user may post a product review in the system, as exemplified in FIG. 6. As shown in FIG. 6 a user may submit a request to the system 601 to present to a user a “post-a-product-review” form which contains data fields accessible to the user. To make such a request, a user may click on a Post link 1106 or activation exemplified in the User Interface depicted in FIG. 12. The button may also appear as an icon, link, object, etc. and may be located on a home page or in any user interface in the system. Now referring back to FIG. 6, at step 603, if a user is not logged in, the system may output a response that invites and/or enables a user to login at step 605 and a message requesting the user to sign-in.

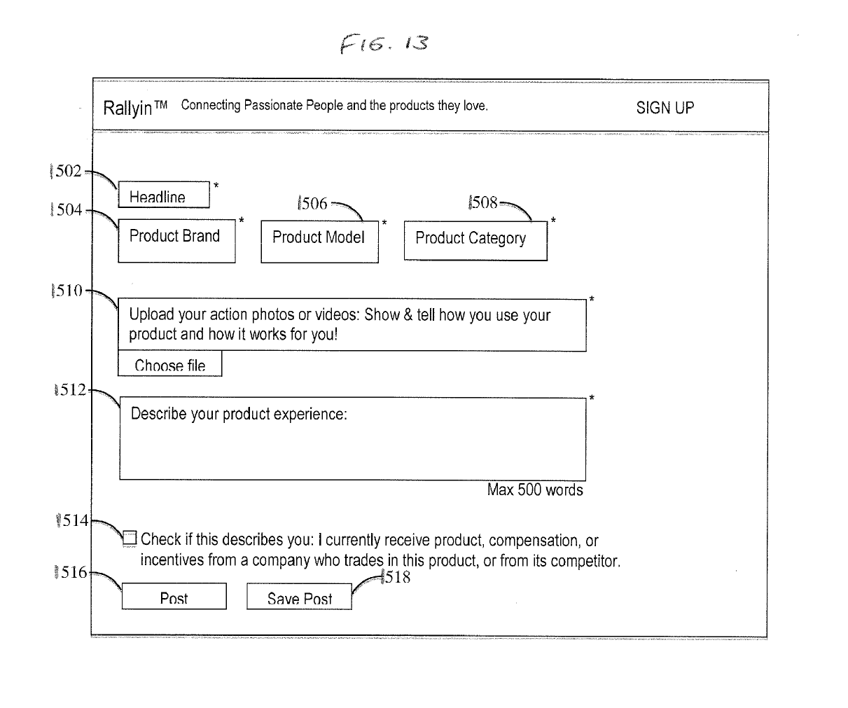

Alternatively, as shown at step 603, if a user is logged in, a user request 607 is made to the system to output to the user a user interface containing a form for creating a product review. At step 609 in response o the request, the system provides an output in the form of a new user interface to create a product review and request that it be posted to the system. An example of a product review form is shown in FIG. 13 which depicts a user interface for entry of product review data. The product review form may require, or may optionally require, a user to input product review data, e.g., including but not limited to a post headline 1502, a product brand 1504, a product model 1506, a product category 1508, one or more videos and/or photos about a product 1510, and a written product review 1512. An exemplary product review form may also include a means for a user to disclose, e.g., including but not limited to if he/she receives compensation from an entity that trades in a product being reviewed in a product review form 1514. The product review form also includes a link 1518 (e.g., including but not limited to, a button, icon, link, object, that a user may activate to save data entries entered in a product review form, to the system. Alternatively, an exemplary product review form may contain a link 1516 (e.g., including but not limited to, a button, icon, or object) that a user may click to submit a product review form to the system and request the system post a form's data entries to a system user interface, e.g., including but not limited to a website, home page, mobile app page.

Saving and posting a post are also represented in an exemplary embodiment of the current invention in FIG. 6. According to the process illustrated in FIG. 6 a user may save data entries entered in a product review form, to the system at step 611. Alternatively a user may submit a request 613 to the system to post or display a form's data entries to a user interface, e.g., including but not limited to a website, home page, and mobile app page. At step 615, if product review data submitted via a product review form is not correct—i.e., the data does not meet the required business rules in the system—then the system may output and display an error message in the product review form at step 617. A user may then correct errors (by entering different data in a product review form) and resubmit a form at step 613. At step 619, if product review data submitted via a product review form is correct—i.e., the data meets (is equal to) required business rules in the system—then the system may output and display (post) product review data to a system user interface, e.g., including but not limited to a website, home page, mobile app page, as depicted in FIG. 9 at field 1108.

In an exemplary product review form as shown in FIG. 13, a product review form”, the system may automatically hashtag data entered in to a product review form, e.g., including but not limited to, a product review headline product brand 1502), a product brand 1504), a product model 1506), a product category 1508, a word or words in a product review 1512. The system also may automatically hashtag data when data matches hashtags stored in the system. The system may hashtag data as a user enters data in a form and/or after the data is submitted to the system. A user may hashtag data as user enters in a product review form.

When the system posts a product review such as that depicted in Fig. e.g., as shown in “User Interface 1—Home Page” 1108) and in Fig “User Interface 4—Personalized Home Page” (108), a hashtag may be displayed (as represented by the hashtag symbol, #).

When the system posts a product review, as shown in data display field 1108 in FIG. 9 the system may include in the post other data that is stored or available to the system including, but not limited to, data and/or metadata the system associates with a user who posts a product review, e.g., including but not limited to a user's photo 1112, a user name 1114, and a user's company name 1116.

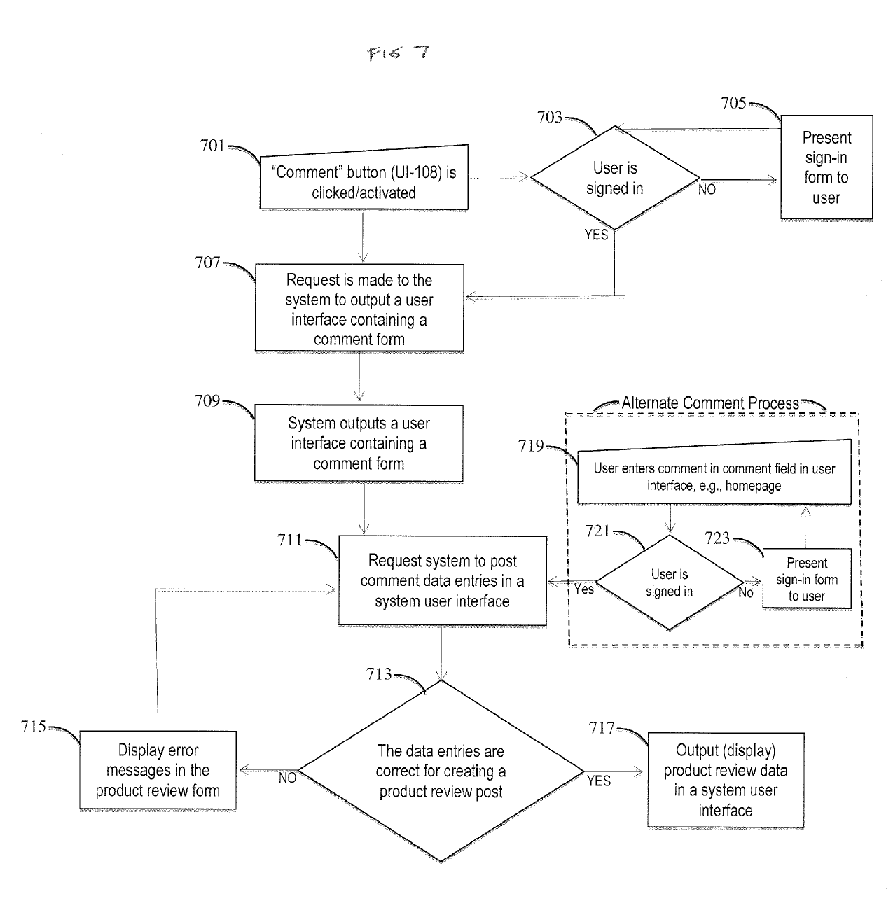

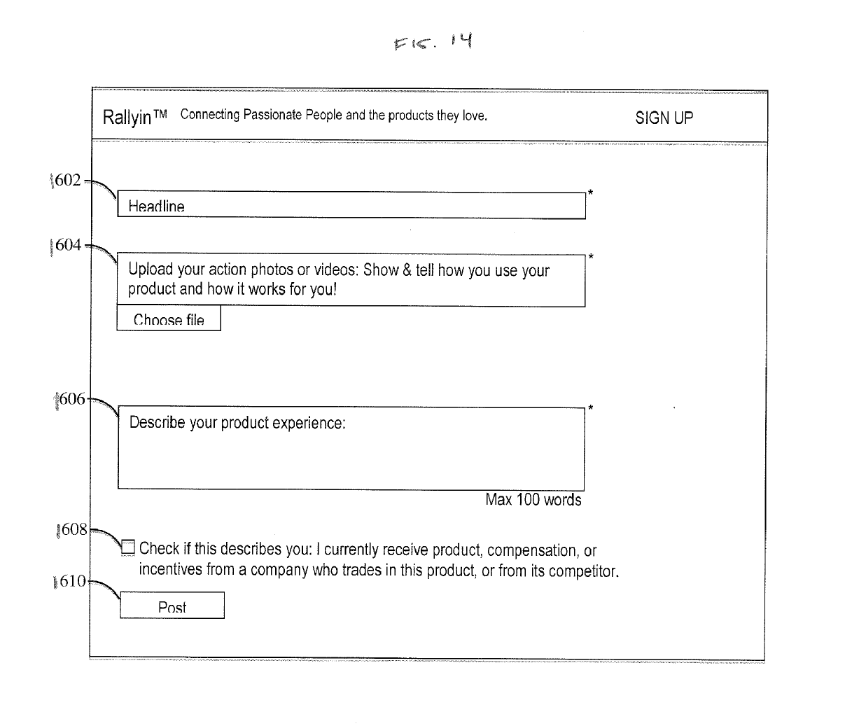

The procedure for posting a comment in a product review area of the website is depicted in FIG. 7. A user begins by submitting a request 701 to present to the user a comment form. To make such a request, a user may click on a comment button as illustrated at link 1110 of FIG. 9. The button may also appear as an icon, link, or object and may be located on a home page or in any user interface in the system. Next at step 703, if a user is not logged in, the system may output a response that invites and/or enables a user to login at step 705. Alternatively, as shown in step 703, if a user is logged in, a user's request 707 may be made to the system to output to the user a user interface containing a comment form. Upon receiving such a request, at step 709 the system outputs an interface containing a comment form and that provides a means for a user to request that a comment be posted to a system user interface. Referring now to FIGS. 13 and 14 a comment form may require, or may optionally require, a user to input comment data, e.g., including but not limited to a comment headline 1602, one or more videos and/or photos about a product 1604, and a written comment 1606. A comment form may also include a means for a user to disclose whether or not the user receives compensation from an entity that trades in a product being commented on in a comment form 1608. An comment form may contain link 1610 that a user may activate to submit a comment form to the system for subsequent publication and request the system post a form's data entries to a system user interfaces. In embodiments, the system may provide inducements for user have to provide input including free goods, coupons, or monetary compensation.

In connection with the comment posting feature, a user may submit a request 711 to the system to post (display) a form's data entries to a user interface that may include but is not limited to a website, home page, or mobile app page, etc. At step 713, if comment data submitted via a comment form is not correct—i.e., the data does not meet (is not equal to) required business rules in the system—then the system may output and display an error message in the comment form 715. A user may then correct errors (by entering different data in a comment form) and resubmit a form at step 711. Still referring to FIG. 7, at step 713, if the comment data submitted via a comment form is correct—i.e., the data meets (is equal to) required business rules in the system—then the system may output and display, append, and/or post comment data to an existing posted product review in a system user interface.

Referring now to FIG. 14, as data is entered in the comment form, the system may automatically hashtag data entered in a comment form including but not limited to, a comment headline 1602, a word or words in a comment 1606. The system also may automatically hashtag data when data matches hashtags stored in the system. The system may hashtag data as a user enters data in a form and/or after the data is submitted to the system. A user may hashtag data a user enters in a comment form.

When the system posts a comment, e.g., as shown in FIG. 9 at field 1118 and FIG. 13 at field 1108), a hashtag may also be displayed as represented by the hashtag symbol, #. When the system then posts a comment, as shown in FIG. 9 at field 1118, the system may include in the post other data that is stored or available to the system including, but not limited to, data and/or metadata the system associates with a user who posts a comment, e.g., including but not limited to a user's photo 1120), a user name 1122 and the a user's company name.

A further feature of the system is dynamic post content as depicted in FIG. 9 at dynamic content panel 1124. Dynamic content may include, e.g., but is not limited to, trending posts, most commented on posts, most shared posts, most followed posts, most read posts, product offers (i.e., products for sale), posts the system may determine are most likely to be of interest to a logged in user, system blogs, etc. The system may dynamically change content, e.g., including based upon algorithms, statistical predictions, etc. and for various business objectives including, but not limited to, optimizing profits, optimizing sales transactions, optimizing sharing, optimizing following, optimizing commenting, optimizing posting, optimizing reads of posts, and optimizing membership. When a user clicks on a content item, such as a post, blog, etc., the item contents may open to reveal its full content. This content may include but is not limited to as a web page, a popup window, a modal window, as frame in a web page, as a page in a mobile app, etc.

In embodiments a user interface also contains “trending content” as depicted in the home page of FIG. 9. and which is displayed in a trending content panel 1126. Trending content may include but is not limited to lifestyles, example lifestyles and/or hashtags that are the most shared, most followed, most commented on and most read. The central system processor can executes an algorithm that uses the data described above to identify and determine trending information or the criteria may be selected by an administrator. When a user clicks a link on a trending content item, posts associated with the selected item may be listed in a user interface, in the center field 1108 of a home page.

Like services offered by conventional social networks, the system allows a user to create and store a personalized home page. In an exemplary embodiment of the current invention, a logged in user may view a personalized home page, e.g., as shown in FIG. 12, a personalized user home page. For example, a user's view 1128 and 1130 may default to show a user's interest, beliefs, desires, intentions, etc. including, e.g., but not limited to, lifestyles, hashtags, products, users, sellers, who and/or what a user is following, who is following a user, posts the system recommends, etc. A personalized view may appear automatically when a user logs in or manually at the request of the user.

A user may determine default personalization content. Alternatively, the system may automatically create a default personalization page. The system may create a user's personalized page based upon a user's interaction on the site, e.g., including a user's social graph, what a user reads, who a user interacts with, what a user buys, posts a user follows, shares, comments, on etc., what a user posts, what a user comments about, a user's hashtags, etc. Because users may be defined as products and services, the personalized home pages may further include such product information. The personalized home page may also be the default page a user sees immediately after logging in.

A further feature of the invention is referred to as the “follow feature.” In this feature, a user, in an exemplary embodiment of the current invention, may follow posts, comments, blogs, by activation of a link that directs the user to another website landing page. FIGS. 9 and FIG. 12 include a depiction of a follow link 1132. A user may follow, including but not limited to, a hashtag, a product, a person, a company, a brand, a product model, a product category, a post, a comment, a product offer. A user may also view who is following the user as exemplified in FIG. 12 by accessing link 1128.

Users in embodiments of the invention may share posts, comments, blogs, etc. by activating a link. As illustrated in FIGS. 9 and 13 at field 134 illustrates a share button. A user may share, a hashtag, a product, a person, a company, a brand, a product model, a product category, a post, a comment, and a product offers. Sharing includes sharing via email, and/or to communications within a social network. Thus the sites may contain blogs created by the administrator or third parties. The site may also serve as a location to republish blogs and forums of others to our site as well as serve as a portal to other bloggers and forums—similar to a portal feature for retailers and manufacturers. In addition the site may include links, including posts, that link to bloggers, forums, etc to others.

A further feature of the invention includes an external product review link, which may be placed and/or installed including but not limited to on a third party site, or external site, third party blog, a blog, a mobile application, or in a browser. When the button for the link activated clicked, it may display and/or link to a display of one or more posts, for example a product review post located within the exemplary invention, and that is associated with one or more products on the third party site. For example, a company operating as Widget Manufacturing may sell widgets on its own site. The company may place product review button on its site. When a user clicks on the button, a viewable entity such as a window, popup window, modal window, may open on the site that contains product reviews of products sold on the Company site.

A further feature of embodiments of the system according to the invention is a external product review feed which may be placed and/or installed on a third party site, or external site, third party blog, a blog, a mobile application, and in a browser. The feed may display one or more posts, which include for example a product review post located that is associated with one or more products on the third party site. For example, a company operating as Widget Manufacturing may sell widgets on its own site. The company may place and/or install an exemplary external product review feed button on its site. When a user clicks on the button, a viewable entity such as a window, popup window, modal window, etc. may open that contains product reviews of products sold on the site.

Yet a further optional feature of the system is a external product posting link that that may be accessed on a third party site, or external site, a mobile application, in a browser, etc. When the link is activated a user may create and post a product review, or a product review comment, on a site, page, application, etc. within the system. For example, a company operating as Widget Manufacturing may sell widgets on its own site. The company may place and/or install an external product posting button on its site. When a user clicks on the button, a viewable entity such as a window, popup window, modal window, etc. may open on the Widget Mfgr site where a user may enter such a product review or product review comment and the information is then shared, accessible and searchable within the system sites.

Embodiments of the current invention further provide a product or service offer portal or access. A user may post a product for sale on a system user interface. The system then automatically places the product offer, e.g., including but not limited to in proximity to an existing product review post that may be relevant to an offer, with trending content, with dynamic content. If the product is located on a particular user's profile page, or comments about the product lead to a sale of the product, the invention may operate as an affiliate marketer of online sellers and e-commerce providers. In this example, after a review of a product, the user may provide a product offer link in association with the review. If the purchasers initiate a transaction through the user's link, the user can be compensated or provided with a commission for the transaction. In this regard, the current invention includes an API (Application Program Interface) that a third party, e.g., including but not limited to an e-commerce site, e-commerce provider, online seller, etc., may install within their system and that provides a means for the current invention to act as an affiliate online marketer for the third-party provider, including displaying on the current invention's user interfaces products displayed on the third-party's sites and/or stored in the third-party's system.

The product offer items discussed above provide a means for a seller to post and/or offer products via its affiliated sales outlets including but not limited to its affiliated retailers, dealers, distributors, and online e-tailers.

Embodiments of the system of the invention further include a search function. A user may enter a search term in a search term field 1134 shown in FIG. 9. A search may include but is not limited to, a hashtag, a product brand, a product model, a product category, a user, a company, etc and will result in a search of all reviews, comments, product descriptions, and product offers and lifestyle or affinity group matches.

Further embodiments of the invention enable a user to post a general inquiry into the system such as a request, search, query, etc. for information about a product or products (including a service or services). The result of the inquiry may be an output of:

a) one or more product reviews existing in the system that may be correlated and/or relevant to the inquiry, and/or
b) a notification of the inquiry to other system members (accounts) whose profiles and/or past product reviews and interactions with the system may correlate and/or be relevant with the inquiry. The notification may request an identified member (account) to post a response (product review) that may answer the inquiry.

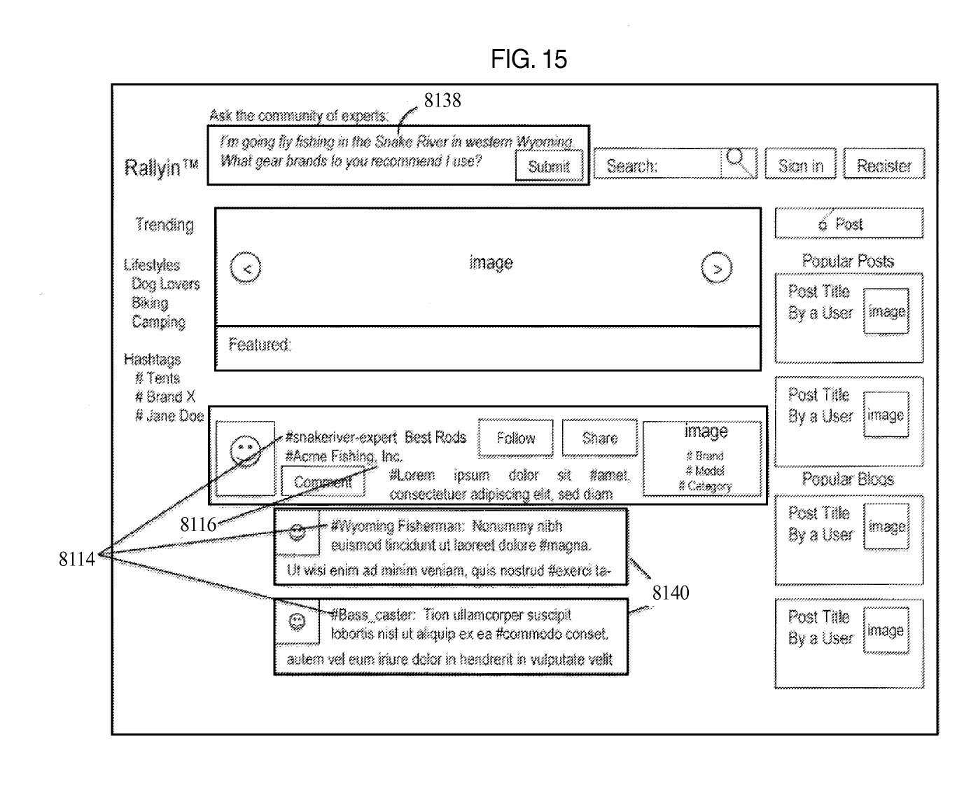

For example, referring now to FIG. 15, a user may enter an inquiry into a system at a user interface 8138 that reads, “I'm going fly fishing in the Snake River in western Wyoming in June. What gear, by brand, do you recommend I consider taking with me? In reply to this inquiry, the system may:

a) display one or more posts existing in the system about the inquiry subject matter, e.g., fly fishing, fishing in the Snake River, fishing in Wyoming, etc. at field 8116.

b.) send a notification, via an email, a text, a mobile app notification, a browser notification, or other means to users who may have indicated expertise with fly fishing in the Snake River of Wyoming and display the users's user names at 8140. Indication of such expertise may result of a user's interaction history with the system and in other systems, including e.g., but not limited to, a user's profile, a user's interests, a user's product purchase history, the profiles of other people a user has historically interacted with, the content of a user's posts and/or comments including, e.g., but not limited to key words, hashtags, etc., a user's demographics, who or what a user follows, who follows a user, a user's expertise ranking, to where a user has shared past posts.

A notification sent to a user may include but is not limited to an inquiry from another user and an invitation to post an answer to the inquiry in the form of a product review, including but not limited to a multi-media product review. A recipient of a notification may include but is not limited to, a consumer, a fan, a product seller, a brand, a blogger, or a product reviewer.

A further feature of the system provides a group of users that have an affinity to the a search subject in response to a search. In the example above, when a user asked about fishing in the snake river, not only did service providers as an output such as guides and outfitters, but people that have either indicated on their user profile that they have been to the Snake River, or live near the Snake River or have commented about the Snake River and experts on the Snake River are displayed in response to the search. The search engine locates not only products and services but also other users and displayed the user profiles in a separate and distinct search result frame or location. As such the user can easily see what results relate to product offers, users, product reviews, comments and product information because each category of search results are displayed in a different search frame that this clearly identified.

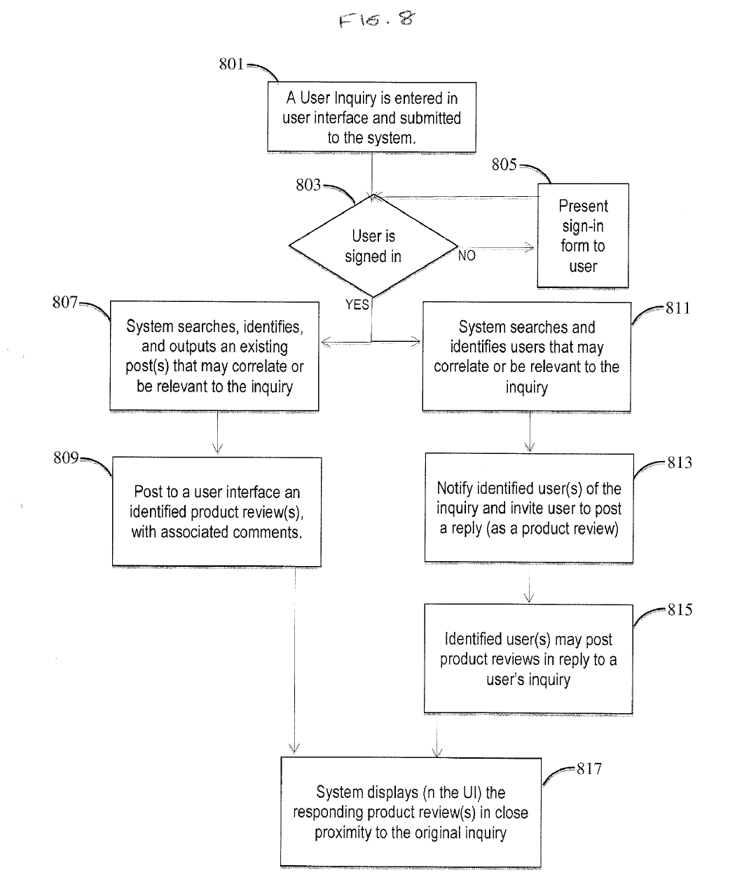

As shown in FIG. 15, a user may enter an inquiry through the data field 8138 user inquiry is also depicted in process flow diagram FIG. 8 at step 801. Next, as shown in steps 803 and 805, the system may determine whether a user is logged in as a condition of whether to proceed with such an inquiry. In step 807 the system requests the system to search, identify, and output to a user interface one or more product review posts existing in the system that may correlate and/or may be relevant to an exemplary inquiry. Now referring to FIG. 15 an outputted posts for the search match connect features is provide at field 8114 shows users with possible correlated and/or expertise in the subject-matter of the inquiry 8138; and reference 8116 shows a company, brand or product with possible correlated and/or expertise in the subject-matter of the inquiry 8138. These results are further linked to yet further information relating to the company, brand and product and information on how to further explore experts in a particular area. As also shown in FIG. 15, an outputted post may be posted, i.e., displayed, in a user interface with associated comments 8140.

FIG. 8 illustrates the search-match-connect process accruing to the invention. According to this feature, an outputted post may be displayed in a user interface in physical proximity to the location of the posted inquiry at step 819. Comments associated with a post may also be displayed in close proximity to the associated post. Next, in steps 807 and 809, the system searches for and identify users that may correlate and/or may be relevant to the inquiry 811. Then, the system notifies a user about results located relevant to the inquiry, which may include an email, a text, a mobile app notification, or a browser notification or a combination of these communications. The notification may also include an invitation 813 to a notified user to post a product review, which may include but is not limited to a multi-media product review, in response to an inquiry. A notified user may post a product post in response to an inquiry at step 815. A post in response to a notification may be displayed in a user interface in close proximity to the location of the posted inquiry at step 819.

The system can allow a user to search and retrieve an inquiry and an inquiry's responses. The system may also allow the results of such a search to display in a user interface.

Embodiments of the system may automatically associate and/or correlate related system data elements , e.g., including but not limited to users, products, hashtags, product reviews, beliefs, desires, intents, interests, user actions, and/or items of volition, etc. The system may automatically construct social graphs for each data element and/or for any combination among them. The system may automatically create statistical models of each data element and/or any combination of them. The system may automatically create social graphs of each data element and/or any combination of them. The system may automatically create statistical agents of statistical models and/or of social graphs. Social graphs, statistical models, and/or statistical agents may continuously and automatically, e.g., including but not limited to, interact with one another, test hypotheses, make recommendations, and/or update social graphs, statistical models and/or statistical agents based on outcomes of tested hypotheses. Any form of statistics may be used including, e.g., but not limited to general statistics, Bayesian statistics, etc. A contemplated alternative to correlate input requests with a selected output is to define the inputs as multidimensional vectors and then compare the inquiry vectors with those existing vectors in the database. Those vectors that most closely match the input vectors can be as an output which may take the form of a product, product review, an expert or other content summarized in a output filed and linked to a webpage.

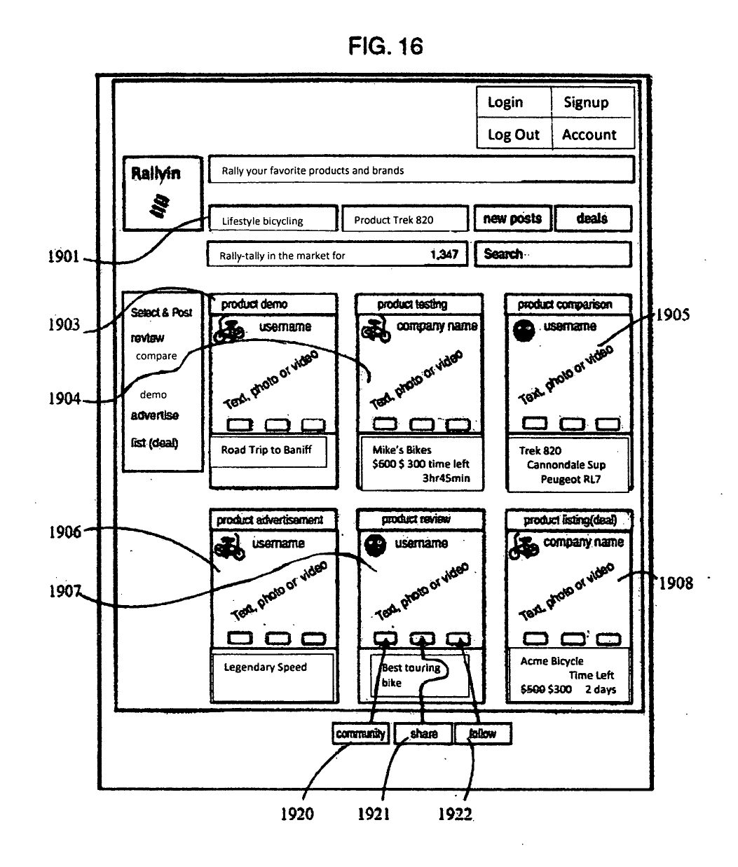

FIG. 16 depicts a webpage according to an embodiment of the invention that includes a selected Bicycling lifestyle 9101 and series of related content windows created by users and which including product demonstrations 1903, products listing for commercial activity 1904, product comparison 1905, product advertisement 1906 and product reviews 1906. In embodiments, users can link to product sales and, if the content poster directs a user to a retailer that completes a sale, the user can be compensated for directing the user. The sites includes features that allows others to comment on the product review 1920, share the product review 1921 and follow the individual that posted the product review 1922.

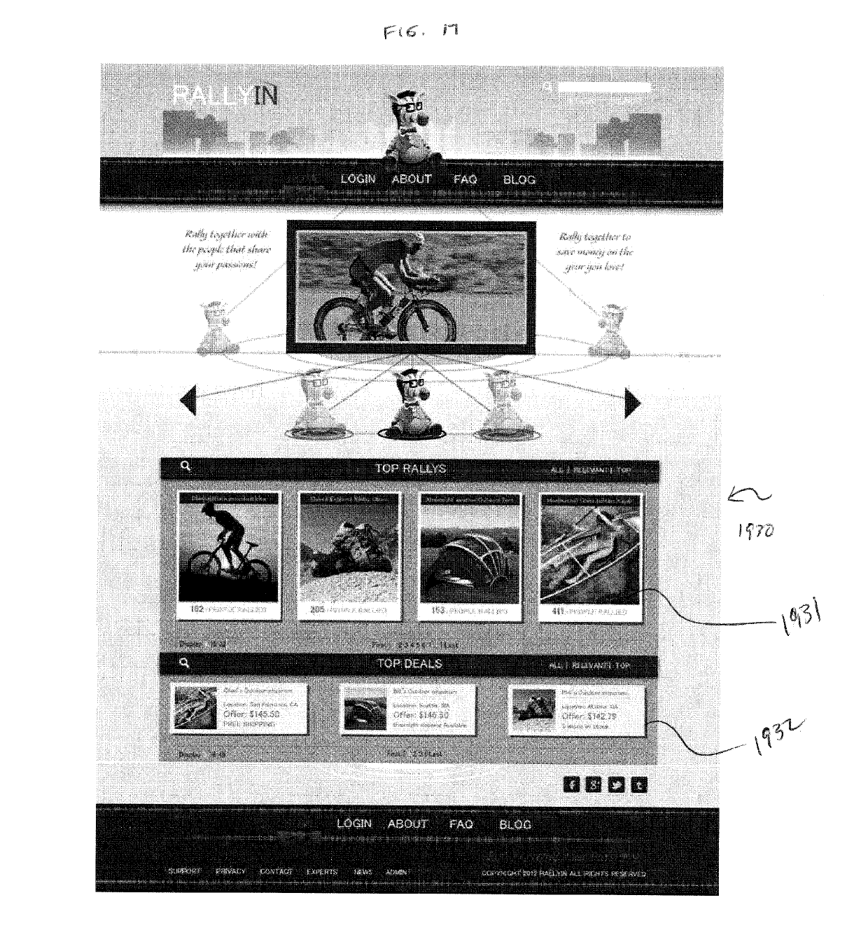

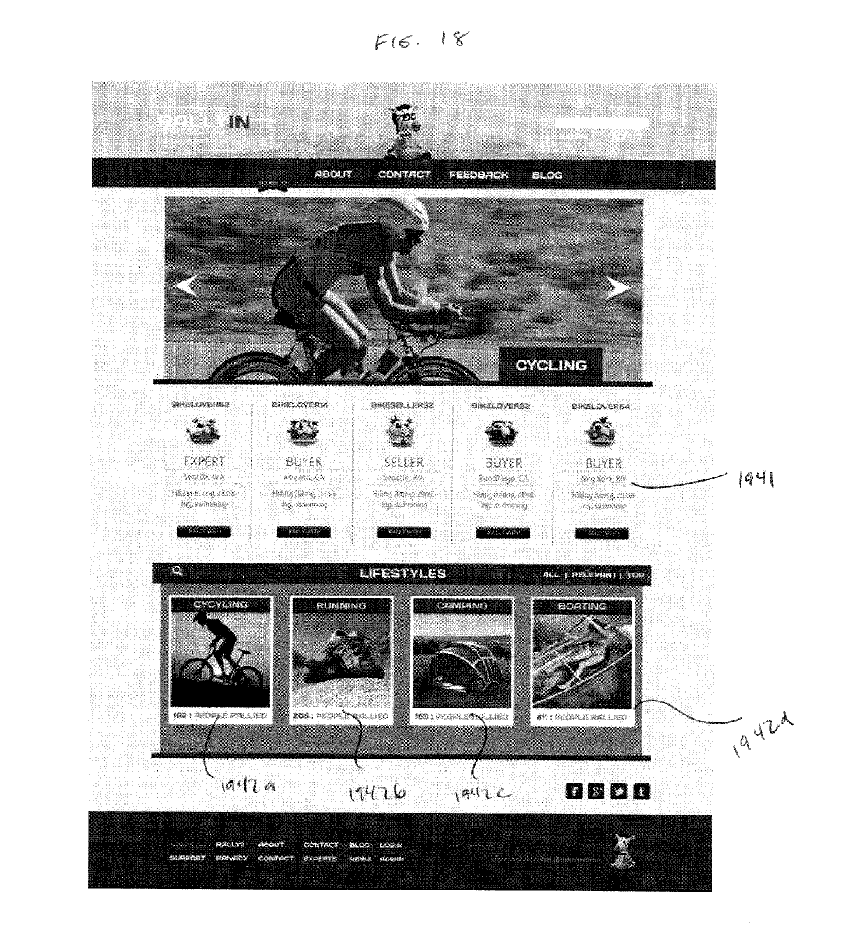

Now referring to FIG. 17, a further screen display 1930 relevant to cycling or a cycling lifestyle is displayed. The screen identifies top rallies 1931 relating to cycling for a predetermined time period and top product offers 1931, each of which can be accessed by the user to open new web pages relevant to icon or panel. FIG. 18 depicts a further webpage that is linked to the cycling lifestyle page and includes a list of a series of members 1941 that have affiliated with the lifestyle. Icons 1942a-1942d located below the members listing provide links to other preselected lifestyles to which a user may chose to affiliate.

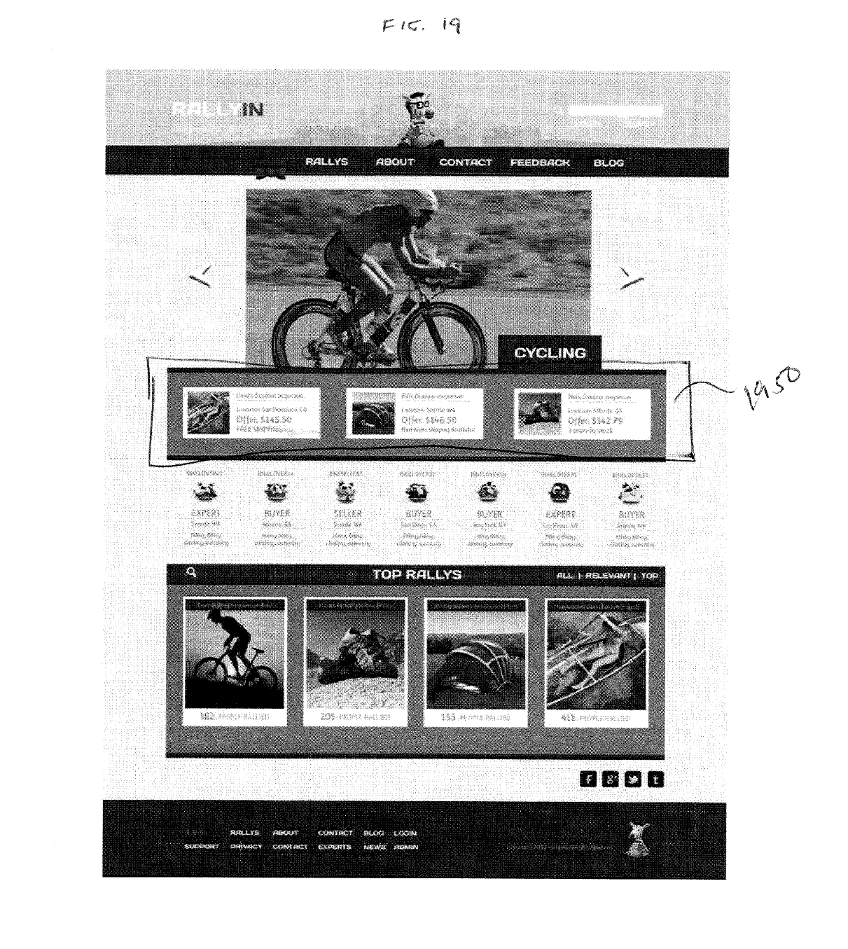

FIG. 19 is a display of a website relating to the cycling lifestyle that further includes offer links that may be periodically displayed or be displayed in response to user input. For example, if a user has indicated that he or she is in the market for a new bicycle helmet, relevant product offers will be displayed at the field 1950.

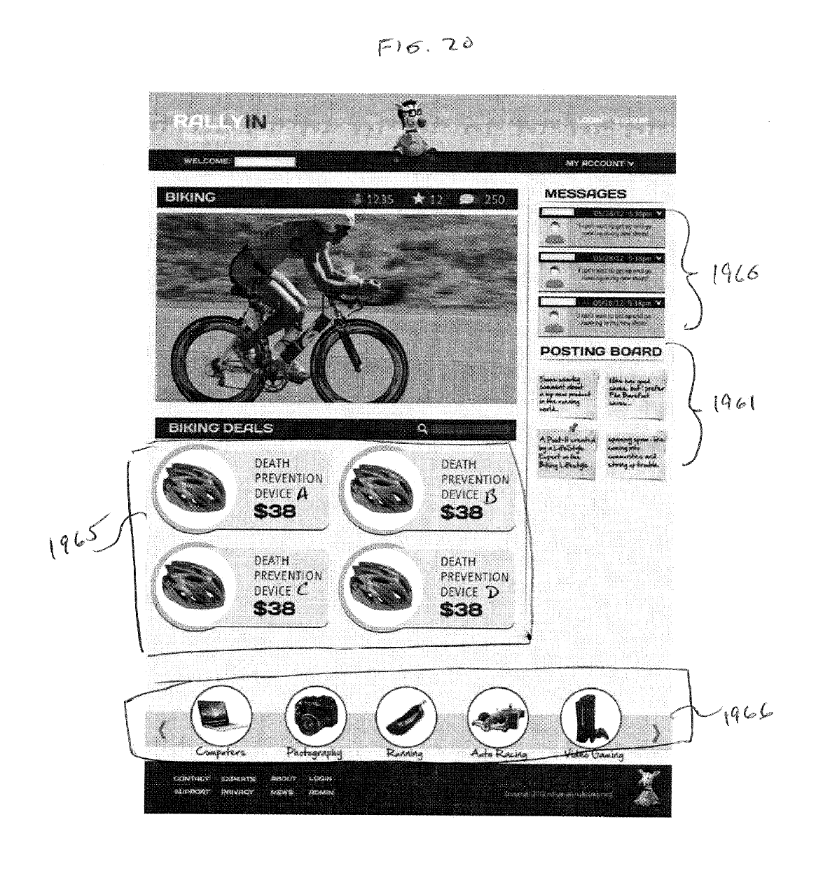

FIG. 20 is yet a further screen display that depict series of relevant offer sin the cycling lifestyle section of the webpage. The website includes messages 1960 and posts 1961 from users that have relevant contact with respect to advertising at field 1965. Thus when field 1965 is displayed, the system searches for relevant content in the form of product reviews, message and posts relating to the product that have been depicted in field 1965 that can be accessed by the user. Other lifestyle links are located at the bottom of the screen in field 1966.

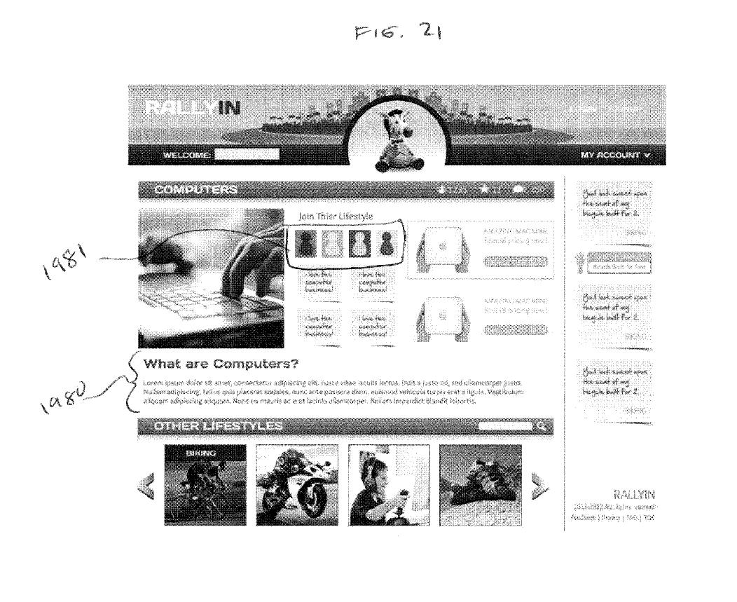

FIG. 21 depicts a screen capture relating to a lifestyle selected that a user may affiliate with. The screen display includes general information relating to the lifestyle at field 1980 and an icon 1981 that can accessed to join or affiliate the users profile with the lifestyle.

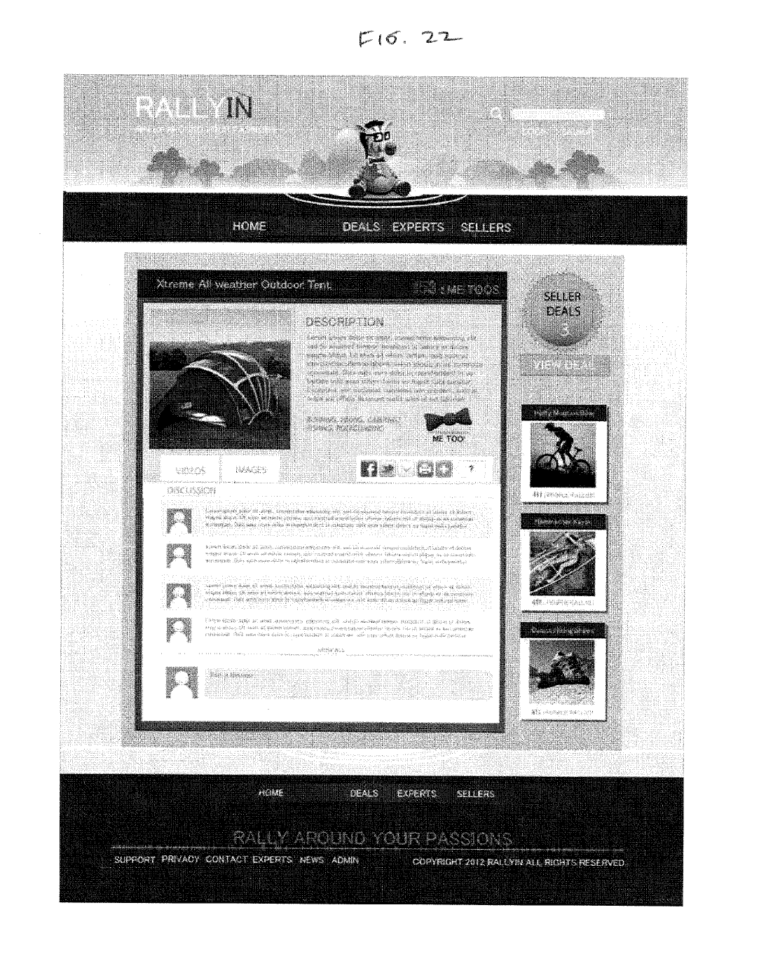

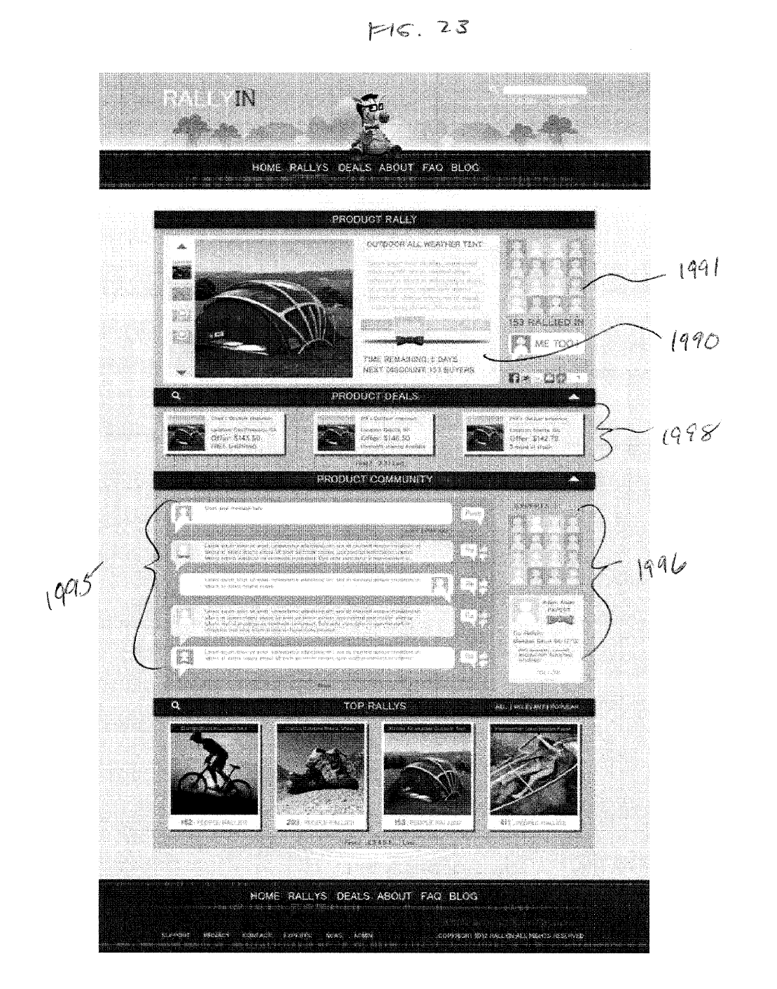

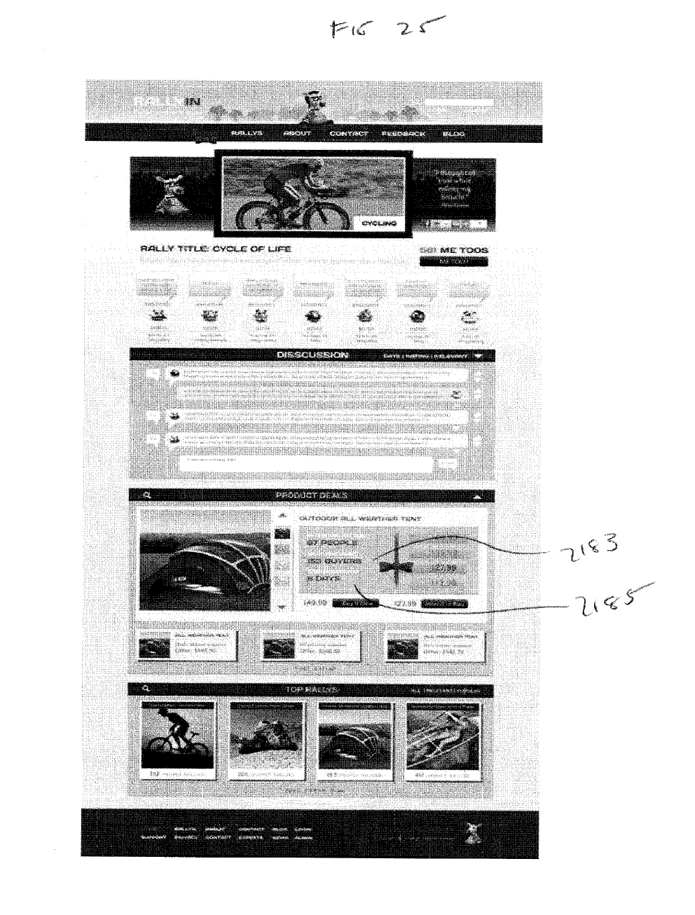

FIG. 22 is a screen display depicting an exemplary product rally also referred to as creating a temporary affinity group relating to a particular product. Here a user has expressed interest in a purchasing an all weather tent as reflected in field 1990. The interest in the product, which may be a particular brand or may be any generic product that meets the user demand. When a rally has been initiated, users that have affiliated with the user group are notified and they can join the rally at 1991 and indicate shared interest in purchasing a product, and/or provide comments at filed 1995 and/or expertise 1996 relevant to the products under consideration. It is therefore contemplated that users with particular expertise and indicate such expertise on the user profile. Interested product vendors can be notified with respect to a rally. The rally may have a predetermined starting time and end times and a vendor can respond to a rally by providing a specific offer in response to the rally at field 1998. FIG. 23 depicts a further screen display that further includes details relating to a product offer. The activation of a product offer link in field 1998 opens a new page 2175. The product offer include details relating to the product 2178, readily accessible product reviews and pricing information and other commercial terms of the offer 2178 such as offer expiration or minimum number of purchasers that are required to implement the offer. The page includes a link to purchase at 2180 and the number of products that are offered at the particular terms 2181. FIG. 25 is a further product deal page that includes additional data relating to the offer such as the number of buyers 2183 and the number of days left to purchase the products or service 2185.

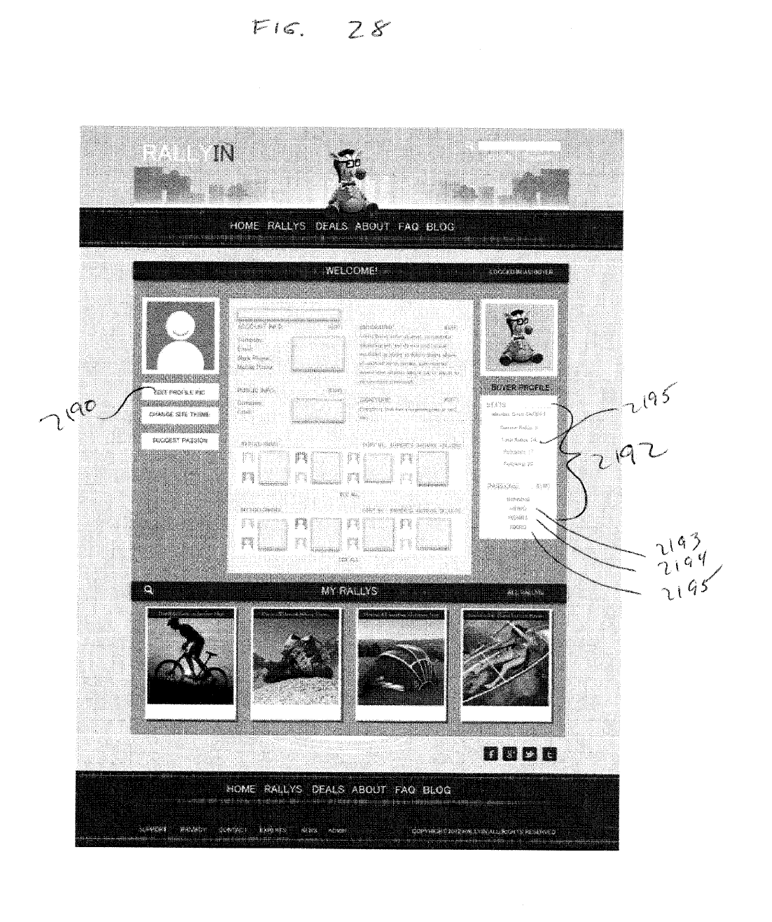

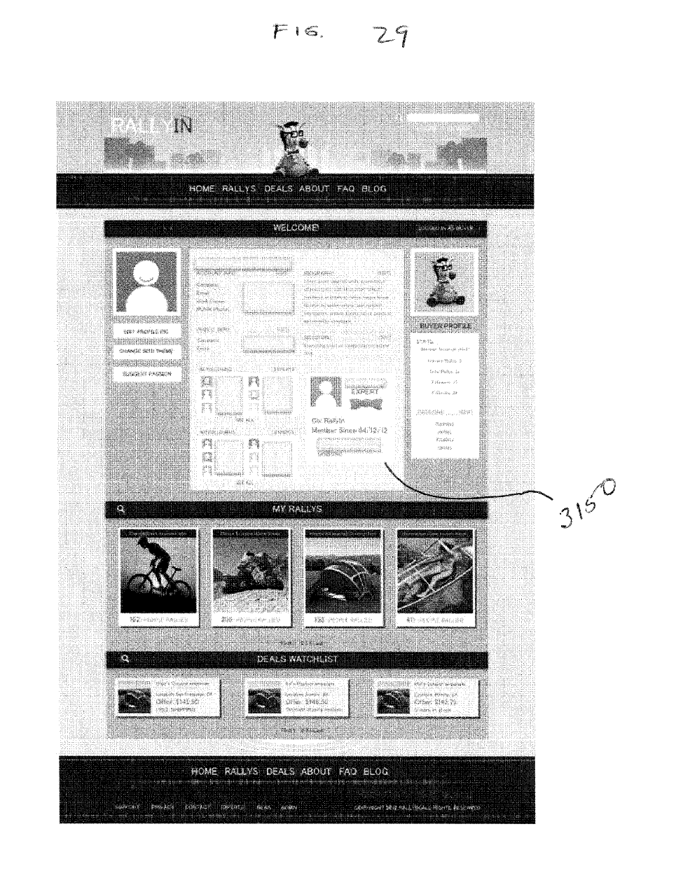

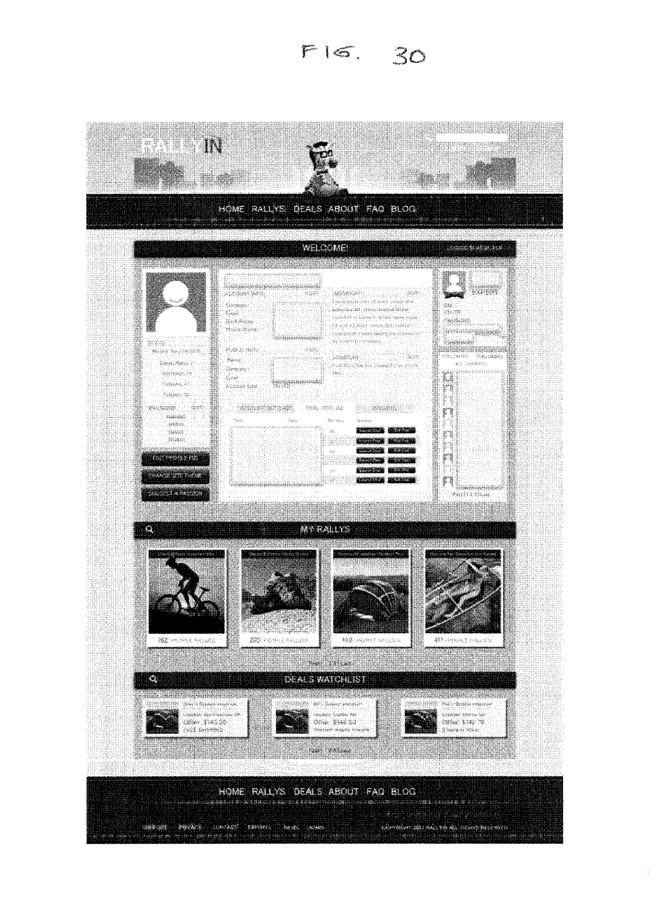

FIG. 28 depicts a welcome screen to the service website. The welcome screen publishes data relevant to the user or subscriber and can be updated by accessing link 2190. The profile also includes data relating to activity of the buyer 2192 including number of Rallys initiated 2195, Rallys participated within, number of messages 2193, number of product reviews 2194 and number of transactions 2195. FIG. 29 and FIG. 30 depict alternative member profile pages and include a fields 3150 and 3151 wherein the member is also identified as an expert. The expert status may by self designed or, in embodiments the website administrator may control the status of expert.

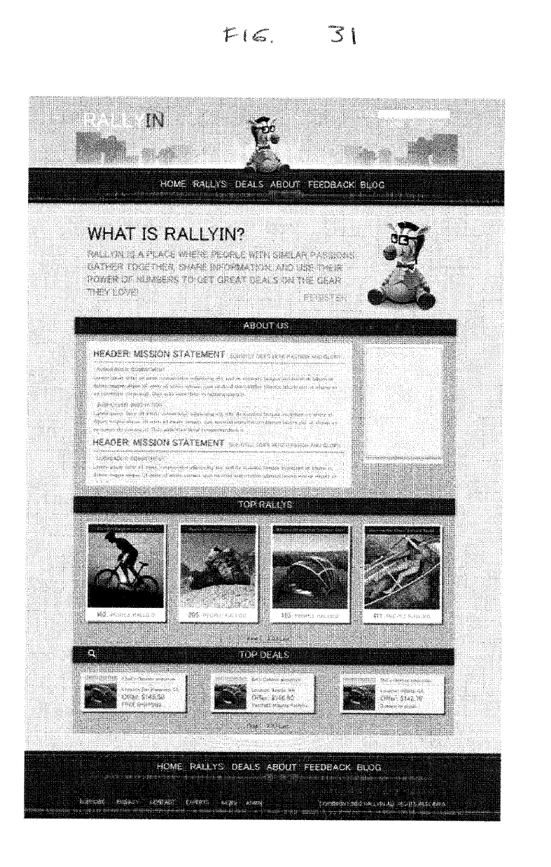

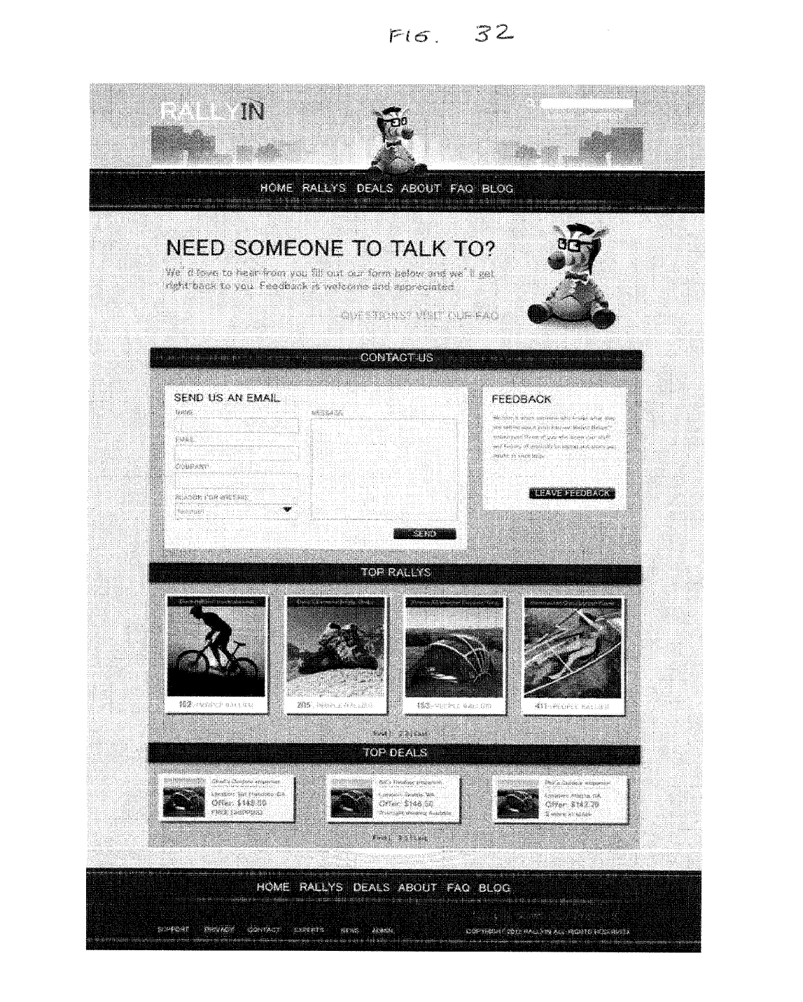

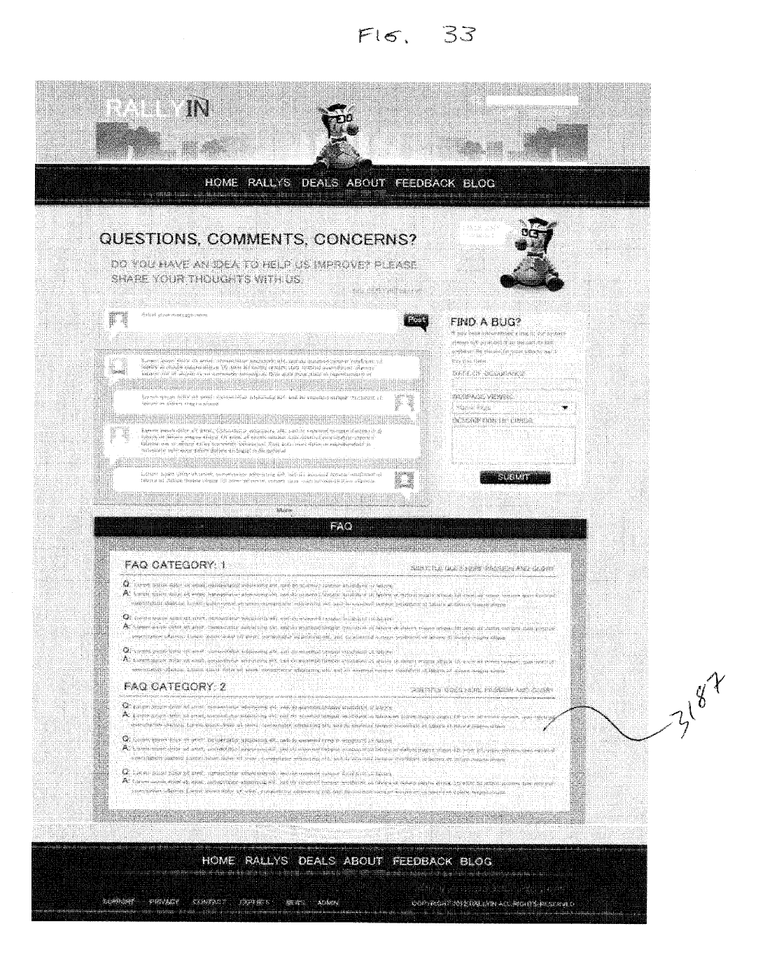

FIG. 30 includes data field 3152 to allow a user to adjust account settings. FIG. 31 is a general information page that describes the services and FIG. 32 is a link that allows subscribers to contact the website administrator to ask questions, alerts and provide feedback. FIG. 33 is a website landing page that allows user to review frequently asked questions 3187.

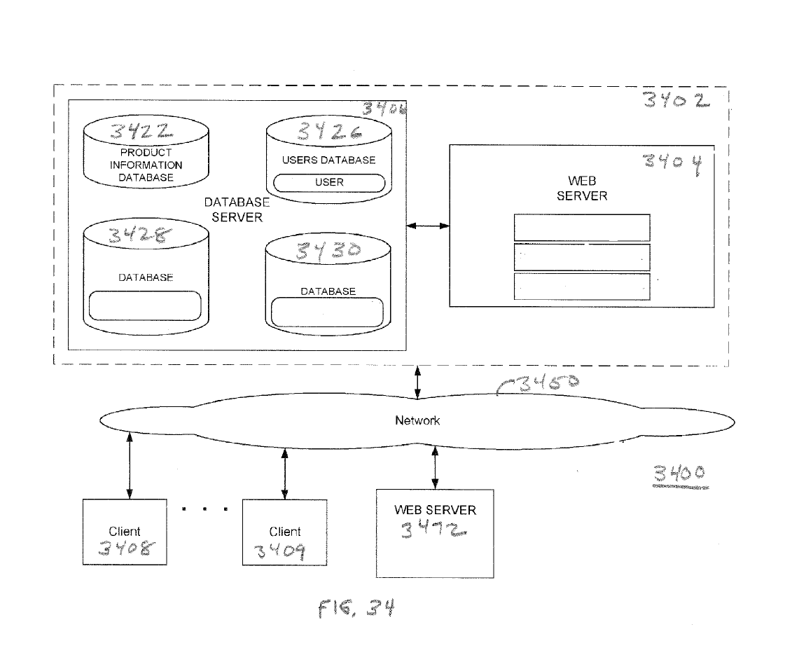

FIG. 34 illustrates a system architecture 3400 in which one preferred embodiment of the present invention may be implemented, including a server system 3402 having a web server 3404 and a database server 3406. A client 3408 and a client 3409 are coupled for communications with the server system 3402 through a network 3450. Multiple server systems and clients, as well as other computer systems may also be coupled to the server system 3402 through the network 3450. For example, FIG. 34 also shows a web server 3472 hosting a social network website. Other websites such as blogging websites may also be coupled to the network 3450. Thus in the search embodiment, the server 3402 may search its own database as well as blogging websites and social networks to indentify relevant responsive information. As described herein, a user, using software on a client computer such as a browser application on the client 3408, interacts with the server system 3402.

Network 3450 includes a variety of networks and may include both local area networks and wide area networks. The functionality provided by the web server 3404, the database server 3406, the client 3408 and the client 3409, as well as by any other computer systems necessary in the network, may be implemented using a computer system having the characteristics of the computer system described herein. The specific implementation of the computer system or systems used to describe the present invention is not to be limiting unless otherwise specifically noted. For example, the functionality provided by the web server 3404 and the database server 3406 may be provided by a single computer system or be distributed over multiple computer systems.

In an embodiment of the present invention, the database server 3406 is implemented as a relational database management system that support the Structured Query Language (SQL) standard as adopted by the American National Standards Institute (ANSI) and the International Organization for Standardization (ISO) to create, retrieve, update and delete data. The terms “database” includes “look-up table” (both in their singular and plural form) are the terms are used interchangeably to indicate the grouping of data and does not indicate the actual configuration of the storage of the data. Thus, although the description contained herein mentions data stored in multiple databases, the data may be consolidated in one database or may be spread over multiple databases configured differently from the version described herein.

In an embodiment of the present invention, the database server 3406 includes user subscription and profile database 3426, a product and service information database 3422, a user review, comment and posting database 3428 and a rally request and rally member database 3430. In embodiments other databases are maintained including an expert database and databases that store data relating to commercial transactions that originate from the database and relate to the affiliate feature.

These databases are used to store the information necessary for the implementation of the various described embodiments of the invention. For example, the user subscription and profile database 3426 includes information related to lifestyles (or likely affinity groups) which may be user created or created by the administrator. The product and service information database provides information from the brand owner. The product review, posting and comment database stores information from subscribers. The expert database stored information relating to experts and their expertise relating to products and services.

A web server program is executed on the web server 3404 to performs the web server functionality described herein, including receiving requests for retrieving or posting information from client computers (e.g., request for files or webpages, or request to post data); interacting with the database server 3406 to retrieve or store any information based on the received requests; and generating and transmitting the necessary information to fulfill those requests (e.g., transmitting files or information necessary for rendering webpages, or confirmation that the data was stored).

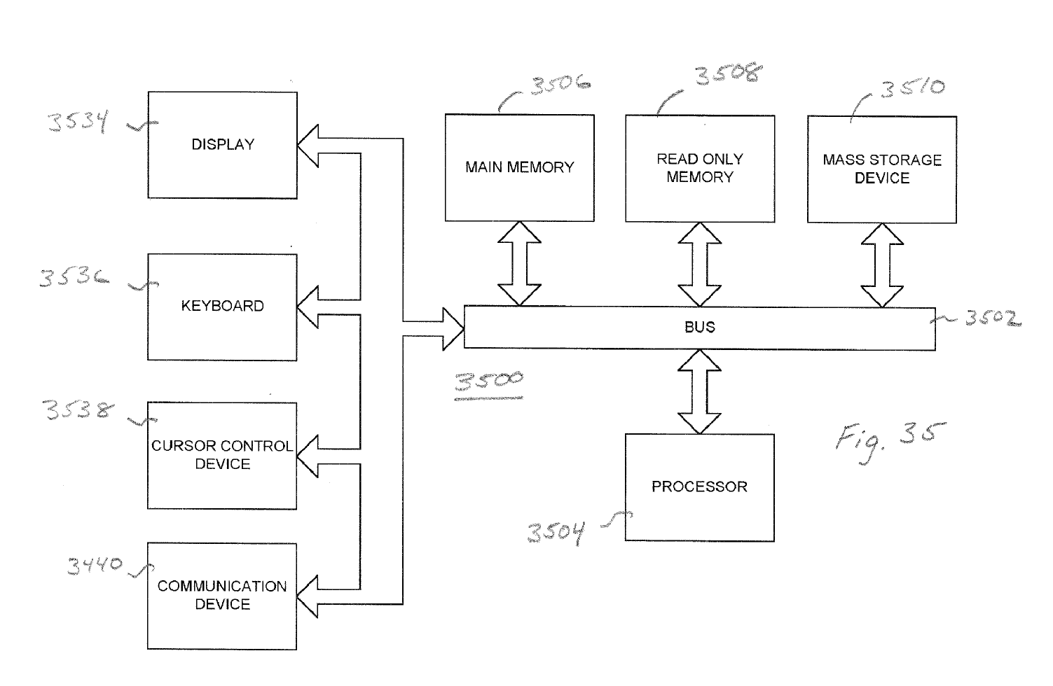

FIG. 35 illustrates an example of a computer system 3500 in which the features of the present invention may be implemented, for instances at a client location. The computer system 3500 includes a bus 3502 for communicating information between the components in the computer system 3500, and a processor 3504 connected with the bus 3502 for executing software code, or instructions, and processing information. The computer system 3500 further comprises a main memory 3506, which may be implemented using random access memory (RAM) and/or other random memory storage device, coupled to the bus 3502 for storing information and instructions to be executed by the processor 3504. The main memory 3506 also may be used for storing temporary variables or other intermediate information during execution of instructions by the processor 3504. The system 3500 also includes a read only memory (ROM) 3508 and/or other static storage device 3510 coupled to the bus 3502 for storing static information and instructions for the processor 3504. A communication module 3440 is also connected to bus 3502 for accessing other computer systems. The communication device 3540 may include a modem, a network interface card, or other well-known interface devices, such as those used for interfacing with Ethernet, Token-ring, or other types of networks. Using the communication elements the computer system may be coupled to a number of other computer systems.

A mass storage device 3510, such as a magnetic disk drive and/or a optical disk drive, is connected to the computer system 3500 for storing information and processing instructions. The computer system is also be connected to a display device 3534, such as a cathode ray tube (CRT) or a liquid crystal display (LCD), for displaying information to a user so that, for example, graphical or textual information may be presented to the user on the display device 3534. Typically, an alphanumeric input device 3536, including alphanumeric and other keys, is connected for communicating information and/or user commands to the processor 3504. Another type of user input device shown in the figure is a cursor control device 3538, such as a conventional mouse, touch mouse, trackball, track pad or other type of cursor direction key for communicating direction information and command selection to the processor 3404 and for controlling movement of a cursor on the display 3534. Various types of input devices, including, but not limited to, the input devices described herein unless otherwise noted, allow the user to provide command or input to the computer system 3500. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, the computer system 3500 may optionally include such devices as a video camera, speakers, a sound card, or many other conventional computer peripheral options.

The user may interact with the information stored in the server system 3402 through browser software in the client 3408. The browser presents a graphical user interface (GUI) to the user. In the following description, the GUI is implemented using one or more webpages (which may be referred to as “pages,” “screens,” or “forms”) provided by the web server 3404 accessible by the user using any Internet web browser software, such as the Internet Explorers browser provided by Microsoft Corp., on a client computer such as the client 3408. As described herein references are made to the user performing such actions as selecting buttons, inputting information on forms, executing searches or updates on the database server 3402. In embodiments, these actions are generated by the user during the user's interaction with the browser. For example, one or more pages described herein include forms that include fields in which the user may type. Once the user has provided such data, the user may select a button or link on the page to submit the information and cause an update of the database server 3406 with the information. The browser will send the web server 3404 the information retrieved from the user using the form, which will cause the information stored on the web server 3410 and the database server 3406 to be updated.

It will be clear to one skilled in the art that the embodiments described above can be altered in many ways without departing from the scope of the invention. Accordingly, the scope of the invention should be determined by the following claims and their legal equivalents.

We claim:

1. A method of creating a social network and related database useful for electronic commerce on a computer network, comprising registering a plurality of users and storing said registration data, providing a framework for said users to create user websites, said user website adapted to receive product reviews, product related posts and product messages, using said registration data and date from said website to create a plurality of user profiles, allowing said user to linking said websites based upon shared affinities, creating a plurality of affinity group websites, and allowing users to create websites and enter data relating to items of commerce, and providing said users a data entry location on a host page to enable said users to create temporary affinity groups relating to items of commerce and transmitting messages to potential interested users for the purpose of consolidating purchasing power and transmitting information relating to said temporary affinity groups to product vendors.

2. The method of creating a social network and related database as recited in claim 1 wherein said user registration data further comprise data relating to user interests and attributes include lifestyle interests which are self-reported in said registration page.

3. The method of creating a database useful for electronic commerce on a computer network recited in claim 1 wherein said user activity on the network is collected and stored, said activity comprising user posts, user product reviews, user comments, user likes, user website visits originating from said network, and user product purchases are saved in said database in said user profile and said user profile is accessible by an algorithm executed by a web server in response to a query.

4. The method recited in claim 1 further comprising providing a user activated and defined affinity group creation function, wherein a system user can publish a need for a product or service to create a temporary affinity group on said network and invite users with similar attributes to join said affinity group, whereby sellers of products and services can access said affinity group and make offers to said affinity group.

5. The method of creating a database useful for electronic commerce on a computer network recited in claim 4 further comprising processing said user published need to identify and weigh characteristic vectors relative to said request and using said vectors to search said user databases to identify potential interested target users that may want to purchase such goods and services and potential vendors of such goods and services, and transmitting a message to said target users and inviting said users join said temporary affinity group, and transmitting messages to said potential vendors, and publishing said data relating to said on a temporary affinity group on a website, wherein vendors can publish offers for items of commerce on said temporary affinity group website.

6. A social network adapted for electronic commerce operated on a computer network said network comprising: a computer including: a processor; a database containing user information, information relating to items of commerce, and information relating to vendors of said items of commerce, a server to distribute web pages to client computers, a memory coupled to the processor, said memory comprising computer-readable code that, when executed, will cause the processor to perform a method to define a plurality of member profiles stored in a database that are associated with an item of commerce, transmitting a message using a communications medium to users associated with said member profiles inviting said to join an temporary affinity group, wherein said temporary affinity group comprises a target market for said items of commerce, and causing said processor to execute an algorithm to define relevant vendors of said items of commerce from vendor profiles stored in a database and transmitting a message using a communication medium to said relevant vendors for said items.

7. The social network recited in claim 6 wherein said social network includes a plurality of user websites, affinity group websites, a host website, vendor websites and items of commerce websites, said websites linked together with a communication media.

8. The social network recited in claim 6 wherein said messages are transmitted by posting said message to an affinity group website and user websites.

9. The social network recited in claim 6 wherein said communication medium comprises transmissions by email.

10. The social network recited in claim 6 wherein users can enter data to create a user profile.

11. The social network recited in claim 6 wherein users can define an affinity group and associate their profile with one or more an affinity group.

12. The social network recited in claim 6 wherein users can select and associate their profile with one or more predetermined affinity group.

13. The social network recited in claim 6 wherein users can create and publish product reviews on said website.

14. The social network recited in claim 6 wherein users can create and publish comments and posts relating to products on said website.

15. The social network recited in claim 6 wherein users can publish commercial information and data relating to products and services for sale in a database accessible through said website.

16. The social network recited in claim 6 wherein users can search said database for data products, product reviews, comments and posts using search terms.

17. The social network recited in claim 6 wherein said users can search a third party website for information.

18. The social network recited in claim 6 wherein users can create and publish user websites and store said data comprising said websites in said user database.

19. The social network recited in claim 6 wherein said user websites comprise a plurality of communication links.

20. The social network recited in claim 6, wherein deploying the first reference link comprises from a user website comprises receiving an identification of a communication medium through which the first reference link is to be deployed; and, deploying the first reference link through the communication medium.

21. The social network of claim 6 further comprising authentication information for accessing a webpage of the user on the website, and posting the first reference link comprises: submitting the authentication information to obtain access to the webpage of the user; and, inserting the first reference link on the webpage of the user.

22. The social network of claim 7, wherein the communication medium comprises an instant message.
